(19) United States
(12) Patent Application Publication
(10) Pub. No.: US 2024/0418526 A1
(43) Pub. Date: Dec. 19, 2024

(54) TRAVEL INFORMATION SHARING METHOD AND APPARATUS, COMPUTER DEVICE, AND STORAGE MEDIUM

(71) Applicant: TENCENT TECHNOLOGY (SHENZHEN) COMPANY LIMITED, Shenzhen (CN)

(72) Inventors: Honglong ZHANG, Shenzhen (CN); Pengcheng ZHAO, Shenzhen (CN); Xiaoya FEI, Shenzhen (CN)

(21) Appl. No.: 18/814,145

(22) Filed: Aug. 23, 2024

Related U.S. Application Data
(63) Continuation of application No. PCT/CN2023/095458, filed on May 22, 2023.

(30) Foreign Application Priority Data
Aug. 18, 2022 (CN) 202210991128.3

(51) Int. Cl. G01C 21/36; G06Q 50/00

(52) U.S. Cl. CPC G01C 21/3667; G01C 21/3664; G06Q 50/01

(57) ABSTRACT

This application provides a travel information sharing method, performed by an on-board terminal, the method comprising: displaying a travel interface of the on-board terminal by using an on-board map application, the travel interface displaying current travel information of the on-board terminal; calling an on-board social application in response to a sharing operation in the travel interface, the sharing operation being configured for indicating sharing the travel information; and sharing, by using the on-board social application, the travel information with a second user associated with a first user, the first user being a user of the on-board terminal logging into the on-board social application.

### RELATED APPLICATIONS

This application is a continuation of PCT Application No. PCT/CN2023/095458, filed on May 22, 2023, which claims priority to Chinese Patent Application No. 202210991128.3, filed on Aug. 18, 2022, and entitled “TRAVEL INFORMATION SHARING METHOD AND APPARATUS, COMPUTER DEVICE, AND STORAGE MEDIUM”, which are incorporated herein by reference in their entirety.

### FIELD OF THE TECHNOLOGY

Embodiments of this application relate to the field of computer technologies, and in particular, to a travel information sharing method and apparatus, a computer device, and a storage medium.

### BACKGROUND OF THE DISCLOSURE

Electronic maps are increasingly used in people's daily lives. For example, the electronic map is used to query a current location, plan a route, navigate in real time, and the like.

### SUMMARY

Embodiments of this application provide a travel information sharing method and apparatus, a computer device, and a storage medium.

According to one aspect, a travel information sharing method is provided. provides a travel information sharing method, performed by an on-board terminal, the method comprising: displaying a travel interface of the on-board terminal by using an on-board map application, the travel interface displaying current travel information of the on-board terminal; calling an on-board social application in response to a sharing operation in the travel interface, the sharing operation being configured for indicating sharing the travel information; and sharing, by using the on-board social application, the travel information with a second user associated with a first user, the first user being a user of the on-board terminal logging into the on-board social application.

According to another aspect, a travel information sharing method is provided. The method is performed by an on-board terminal, and includes displaying a sharing message by using an on-board map application, the sharing message being provided by an on-board social application; and displaying, in response to a trigger operation on the sharing message, travel information associated with the sharing message, the travel information being shared by a third user to a fourth user, the fourth user being a user of the on-board terminal logging into the on-board social application, and the third user having a social relationship with the fourth user.

According to another aspect, a computer device is provided, including a processor and a memory, the memory having at least one computer program stored therein, and the at least one computer program being loaded and executed by the processor to implement the travel information sharing method according to any one of the foregoing aspects.

According to another aspect, a non-transitory computer-readable storage medium is provided, having at least one computer program stored thereon, the at least one computer program being loaded and executed by a processor to implement the travel information sharing method according to any one of the foregoing aspects.

### BRIEF DESCRIPTION OF THE DRAWINGS

FIG. 1 is a schematic diagram of an implementation environment according to an embodiment of this application.

FIG. 2 is a schematic diagram of another implementation environment according to an embodiment of this application.

FIG. 3 is a flowchart of a travel information sharing method according to an embodiment of this application.

FIG. 4 is a flowchart of another travel information sharing method according to an embodiment of this application.

FIG. 5 is a flowchart of another travel information sharing method according to an embodiment of this application.

FIG. 6 is a flowchart of another travel information sharing method according to an embodiment of this application.

FIG. 7 is a flowchart of another travel information sharing method according to an embodiment of this application.

FIG. 8 is a flowchart of another travel information sharing method according to an embodiment of this application.

FIG. 9 is a schematic diagram of a user selection interface according to an embodiment of this application.

FIG. 10 is a flowchart of another travel information sharing method according to an embodiment of this application.

FIG. 11 is a flowchart of a moving progress updating method according to an embodiment of this application.

FIG. 12 is a flowchart of another travel information sharing method according to an embodiment of this application.

FIG. 13 is a schematic diagram of a route planning interface according to an embodiment of this application.

FIG. 14 is a schematic diagram of a route navigation interface according to an embodiment of this application.

FIG. 15 is a schematic diagram of a moving progress report method according to an embodiment of this application.

FIG. 16 is a schematic diagram of another moving progress report method according to an embodiment of this application.

FIG. 17 is a schematic diagram of travel information according to an embodiment of this application.

FIG. 18 is a schematic diagram of another travel information according to an embodiment of this application.

FIG. 19 is a schematic diagram of another travel information according to an embodiment of this application.

FIG. 20 is a schematic diagram of another travel information according to an embodiment of this application.

FIG. 21 is a schematic diagram of a travel information display method according to an embodiment of this application.

FIG. 22 is a flowchart of another travel information sharing method according to an embodiment of this application.

FIG. 23 is a schematic diagram of state management of an on-board terminal according to an embodiment of this application.

FIG. 24 is a flowchart of another travel information sharing method according to an embodiment of this application.

FIG. 25 is a flowchart of another travel information sharing method according to an embodiment of this application.

FIG. 26 is a schematic diagram of a structure of a travel information sharing apparatus according to an embodiment of this application.

FIG. 27 is a schematic diagram of a structure of another travel information sharing apparatus according to an embodiment of this application.

FIG. 28 is a schematic diagram of a structure of another travel information sharing apparatus according to an embodiment of this application.

FIG. 29 is a schematic diagram of a structure of another travel information sharing apparatus according to an embodiment of this application.

FIG. 30 is a schematic diagram of a structure of another travel information sharing apparatus according to an embodiment of this application.

FIG. 31 is a schematic diagram of a structure of another travel information sharing apparatus according to an embodiment of this application.

FIG. 32 is a schematic diagram of the structure of a terminal according to an embodiment of this application.

FIG. 33 is a schematic diagram of the structure of a server according to an embodiment of this application.

### DESCRIPTION OF EMBODIMENTS

The terms “first”, “second”, and the like used in this application may be used for describing various concepts in this specification. However, the concepts are not limited by the terms unless otherwise specified. The terms are merely used for distinguishing one concept from another concept. For example, without departing from the scope of this application, a first user may be referred to as a second user, and similarly, the second user may be referred to as the first user.

In some embodiments of this application, the term “at least one” indicates one or more than one. For example, at least one user indicates one user, two users, three users, or any integer number of users greater than or equal to one. The term “a plurality of” indicates two or more than two. For example, a plurality of users indicate two users, three users, or any integer number of users greater than or equal to two. The term “each” indicates each of at least one. For example, each user indicates each of a plurality of users. If the plurality of users are three users, each user indicates each of the three users.

In some embodiments of this application, related data such as user information and travel information are involved. When the foregoing embodiments of this application are applied to a specific product or technology, a permission or consent of a user is required, and collection, use, and processing of the related data need to comply with related laws, regulations, and standards of related countries and regions.

In an on-board scenario, when a user uses an electronic map application by using an on-board terminal, the electronic map application provides the user with current travel information. To facilitate different users to learn a travel status, how to share the travel information on the on-board terminal conveniently and quickly when traveling is a problem that needs to be resolved urgently.

An electronic map, namely a digital map, is a map that is stored and viewed digitally by using a computer technology. Electronic maps generally stores information by using vector graphics storage. A map scale may be enlarged, reduced, or rotated without affecting a display effect. The electronic map application generally uses a geographic information system to store and transmit map data, and there is also another information system.

The on-board terminal (Transmission Control Unit, TCU) is a terminal device mounted in an on-board environment, and is a peripheral unit of a vehicle management system.

A software development kit (SDK) is a set of development kits used by some software engineers for creating application software for a specified software package, software framework, hardware platform, operating system, and the like. In a broad sense, the software development kit refers to a set of related documents, an example, and a tool that assist in the development of a specific type of software.

Route planning preference refers to an exemplary function for planning a travel route for a user when a navigation function of the electronic map is used. If the user sets a route planning preference, a travel route that satisfies the route planning preference may be recommended first. For example, the route planning preference includes highway first, congestion avoidance, lowest costs, and the like.

A route guidance system (RGS) mainly refers to use of various terminals to provide a driver with guidance information on a vehicle traveling route, assisting the driver in selecting a route and driving on an established route to arrive at a destination, and helping the driver reselect a route when necessary. The RGS may be classified with different methods based on different methods for implementing route optimization and a navigation function.

A state machine (finite state machine) includes a state register and a combinational logic circuit, can transfer a state based on a pre-set state according to a control signal, and is a control center that coordinates related signal actions and completes a specified operation.

A mini program is an application that may be used without the need of download and installation, so that the application is “at user's fingertips”. The user can open the application by scanning or searching. In addition, the mini program also embodies the “Drop after Use” concept, and the user does not need to care about the problem of whether excessive applications are installed. The applications is easily accessible anywhere, and available at any time without the need of installation or uninstallation.

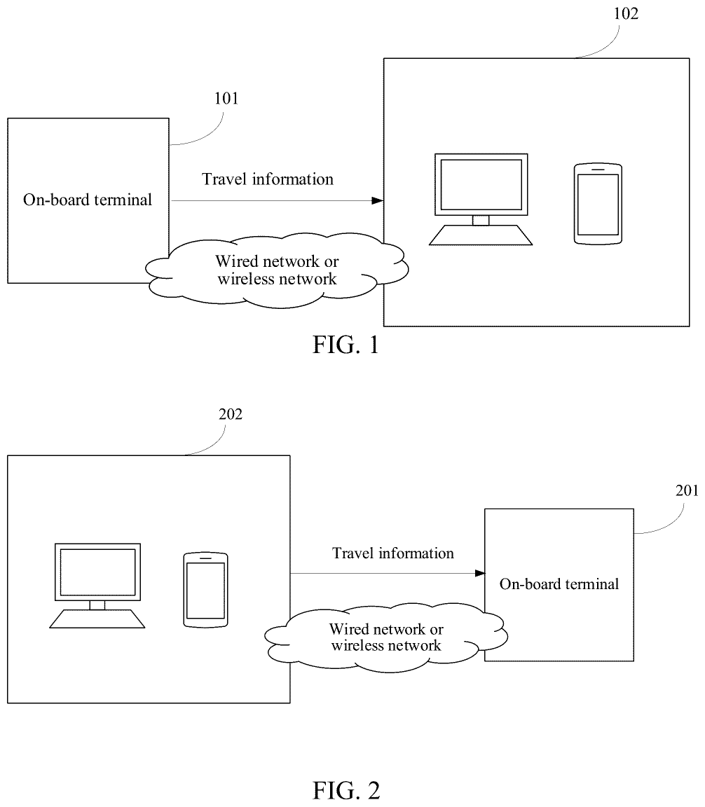

FIG. 1 is a schematic diagram of an implementation environment according to an embodiment of this application. As shown in FIG. 1, the implementation environment includes an on-board terminal 101 and a first terminal 102. The on-board terminal 101 and the first terminal 102 are directly or indirectly connected to each other in a wired or wireless communication manner. The on-board terminal 101 runs an on-board map application and an on-board social application. When a sharing operation is detected by using the on-board map application, the on-board terminal 101 shares travel information with the first terminal 102 by using the on-board social application, so that the travel information of the on-board terminal 101 is shared with the first terminal 102.

In one embodiment, the first terminal 102 is a mobile phone, an on-board terminal, a smart voice interaction device, a smart home appliance, a tablet computer, a laptop computer, a desktop computer, a smart speaker, a smart watch, a Moving Picture Experts Group Audio Layer III (MP3) player, a Moving Picture Experts Group Audio Layer IV (MP4) player, an aerial vehicle, or another type of device.

In one embodiment, the implementation environment further includes a map server. The on-board terminal 101 transmits the travel information to the map server by using the on-board map application, and transmits a sharing request to the map server by using the on-board social application, so that the map server shares the travel information of the on-board terminal 101 with the first terminal 102. In one embodiment, the map server is an independent physical server, is a server cluster or a distributed system including a plurality of physical servers, or is a cloud server that provides basic cloud computing services such as a cloud service, a cloud database, cloud computing, a cloud function, cloud storage, a network service, cloud communication, a middleware service, a domain name service, a security service, a content delivery network (CDN), or big data and an artificial intelligence platform. The on-board terminal 101 and the first terminal 102 are directly or indirectly connected to the map server in a wired or wireless communication manner. This is not limited in this application.

FIG. 2 is a schematic diagram of another implementation environment according to an embodiment of this application. As shown in FIG. 2, the implementation environment includes an on-board terminal 201 and a second terminal 202. The on-board terminal 201 and the second terminal 202 are directly or indirectly connected to each other in a wired or wireless communication manner. The on-board terminal 201 runs an on-board map application and an on-board social application. When a sharing message transmitted by the second terminal 202 is received by using the on-board social application, the on-board terminal 201 displays the sharing message by using the on-board map application. In addition, when the sharing message is triggered, travel information associated with the sharing message is displayed. In this way, the travel information of the second terminal 202 is shared with the on-board terminal 201.

In one embodiment, the implementation environment further includes a map server. The second terminal 202 transmits the travel information and a sharing request to the map server, so that the map server shares the travel information of the second terminal 202 with the on-board terminal 201. The on-board terminal 201 and the second terminal 202 are directly or indirectly connected to the map server in a wired or wireless communication manner. This is not limited in this application.

The travel information sharing method provided in some embodiments of this application may be applied to any travel scenario.

For example, the travel information sharing method is applied to a scenario in which an on-board terminal shares travel information with a first terminal. The first terminal is an on-board terminal or a non-on-board terminal. A user uses the on-board terminal for navigation while driving. The on-board terminal runs an on-board map application and an on-board social application. The on-board map application provides current travel information, such as a travel route or a moving progress. If the user wants to share the travel information with a friend in the on-board social application, the user performs a sharing operation by using the on-board map application. When the sharing operation is detected, the on-board terminal shares the travel information with the friend in the on-board social application, so that the friend can learn a travel status of the user, and information exchange efficiency between the on-board terminal and an external terminal is improved.

In another example, the travel information sharing method is applied to a scenario in which an on-board terminal receives travel information shared by a second terminal. The second terminal is an on-board terminal or a non-on-board terminal. A user uses the on-board terminal for navigation while driving. The on-board terminal runs an on-board map application and an on-board social application. When a sharing message associated with the travel information is received from a friend by using the on-board social application, the sharing message is displayed by using the on-board map application. If the user wants to view the travel information of the friend, the user performs a trigger operation on the sharing message. When the trigger operation is detected, the on-board terminal displays the travel information of the friend in the on-board map application, so that the user can learn a travel status of the friend, and information exchange efficiency between the on-board terminal and an external terminal is improved.

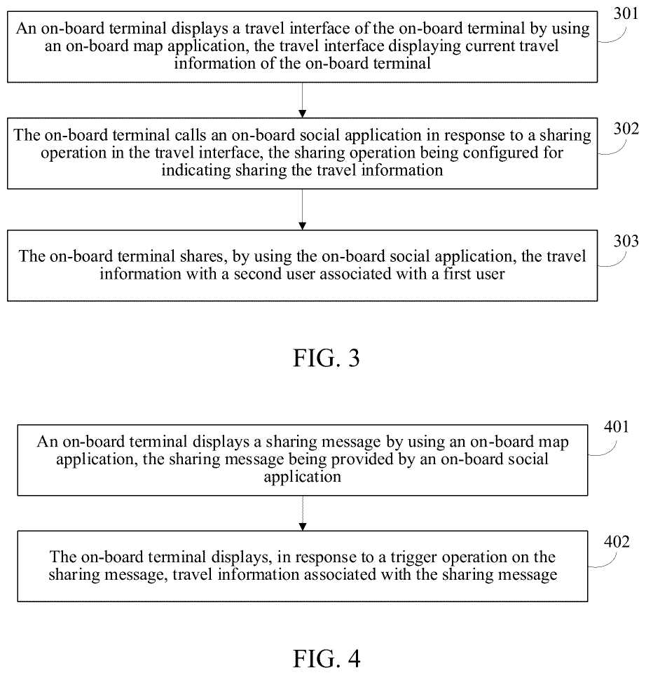

FIG. 3 is a flowchart of a travel information sharing method according to an embodiment of this application. This embodiment of this application is performed by an on-board terminal. As shown in FIG. 3, the method includes the following.

301: The on-board terminal displays a travel interface of the on-board terminal by using an on-board map application, the travel interface displaying current travel information of the on-board terminal.

The on-board terminal is a peripheral unit of a vehicle management system and is mounted in a vehicle. The on-board terminal runs an on-board map application. The on-board map application has an electronic map function, a route planning function, a route navigation function, and the like. The on-board map application displays the travel interface of the on-board terminal, and the travel interface displays the travel information of the on-board terminal.

The travel information is travel-related information during traveling of a vehicle. For example, the travel information includes the travel route, a moving progress, information of the vehicle, surrounding environment information of the vehicle, and the like. The travel route is a route from a start point of a trip to an end point of the trip. The moving progress is a progress of the vehicle moving along the travel route. The information of the vehicle includes the traveling speed and a traveling direction of the vehicle, and the like. The surrounding environment information of the vehicle includes traffic status information of the vehicle route, and the like.

302: The on-board terminal calls an on-board social application in response to a sharing operation in the travel interface, the sharing operation being configured for indicating sharing the travel information.

The on-board terminal further runs an on-board social application. The on-board social application is an application having a social networking function. The social networking function includes a function of transmitting an instant messaging message, a function of publishing a dynamic message, a function of viewing a dynamic message published by a friend, and the like. The social application includes an instant messaging application, an information display application, an electronic payment application, a multimedia data playback application, and the like.

If a user wants to share the travel information of the on-board terminal, the user performs the sharing operation configured for indicating sharing the travel information. The on-board terminal calls the on-board social application in response to the sharing operation.

303: The on-board terminal shares, by using the on-board social application, the travel information with a second user associated with a first user.

The on-board terminal calls the on-board social application, and shares, by using the on-board social application, the travel information of the on-board terminal with the second user associated with the first user. The first user is a user of the on-board terminal logging into the on-board social application, and the second user is any user having a social relationship with the first user. For example, the first user and the second user are accounts in the on-board social application. Alternatively, the second user is a group in the on-board social application, and the group includes a plurality of accounts. The sharing operation is performed, so that the travel information of the on-board terminal is shared with a friend. In this way, a sharing process of the travel information is simplified, a technical link of sharing the travel information is shortened, difficulty of sharing the travel information is reduced, convenience of operations is improved, and information exchange efficiency of different terminals is improved.

According to the method provided in this embodiment, the on-board terminal runs the on-board map application and the on-board social application. The travel interface displayed by the on-board map application provides the current travel information of the on-board terminal, and the first user logs in to the on-board social application. When the sharing operation configured for indicating sharing the travel information is detected by using the on-board map application, the on-board terminal calls the on-board social application to share the travel information of the on-board terminal with the second user that has the social relationship with the first user. The travel information of the on-board terminal is shared with another user by triggering the sharing operation. In this way, the travel information of the on-board terminal is shared quickly in an on-board scenario, the sharing process of the travel information by the on-board terminal is simplified, and efficiency of sharing the travel information by the on-board terminal is improved.

FIG. 4 is a flowchart of another travel information sharing method according to an embodiment of this application. This embodiment of this application is performed by an on-board terminal. As shown in FIG. 4, the method includes the following.

401: The on-board terminal displays a sharing message by using an on-board map application, the sharing message being provided by an on-board social application.

The on-board terminal runs the on-board map application and the on-board social application. The on-board social application can obtain the sharing message and provide the sharing message for the on-board map application. The sharing message is associated with travel information. The travel information is shared by a third user to a fourth user. The fourth user is a user of the on-board terminal logging into the on-board social application. The third user has a social relationship with the fourth user.

402: The on-board terminal displays, in response to a trigger operation on the sharing message, the travel information associated with the sharing message.

If a user wants to view the travel information associated with the sharing message, the user performs the trigger operation on the sharing message. The on-board terminal displays, in response to the trigger operation on the sharing message, the travel information associated with the sharing message, so that the user is allowed to view travel information shared by the third user.

According to the method provided in this embodiment, the on-board terminal runs the on-board map application and the on-board social application. The on-board map application provides travel information for the on-board terminal. The fourth user logs into the on-board social application. When the sharing message is obtained, the on-board social application provides the sharing message for the on-board map application, so that the on-board terminal displays the sharing message by using the on-board map application. When the sharing message is triggered, the travel information associated with the sharing message is displayed. In this way, the travel information of the third user is shared to the fourth user, and the user can view, on the on-board terminal, the travel information shared by a friend, so that a function of the on-board terminal is expanded, and travel information that can be displayed on the on-board terminal is enriched.

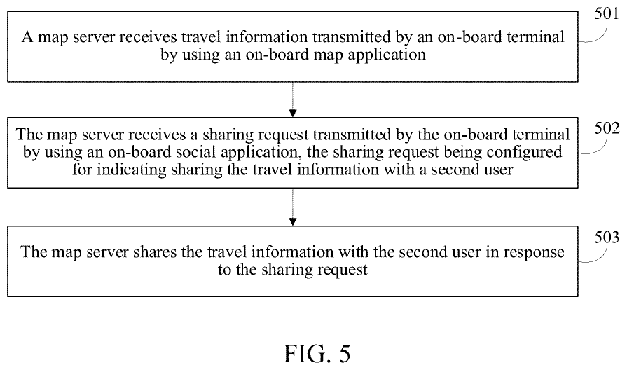

FIG. 5 is a flowchart of another travel information sharing method according to an embodiment of this application. This embodiment of this application is performed by a map server. As shown in FIG. 5, the method includes the following.

501: The map server receives travel information transmitted by an on-board terminal by using an on-board map application.

The map server is a back-end server of the on-board map application. The map server is configured to provide a service for the on-board map application. In addition, the map server further provides an interactive interface for an on-board social application, so that the on-board social application can interact with the map server, to forward and receive information.

In this embodiment, in a scenario in which the on-board terminal shares the travel information, the on-board terminal transmits the travel information of the on-board terminal to the map server by using the on-board map application, and the map server receives the travel information.

502: The map server receives a sharing request transmitted by the on-board terminal by using the on-board social application, the sharing request being configured for indicating sharing the travel information with a second user.

While the on-board terminal transmits the travel information to the map server, the on-board terminal also transmits the sharing request to the map server by using the on-board social application. The sharing request is configured for indicating sharing the travel information of the on-board terminal with the second user. The map server receives the sharing request from the on-board terminal.

503: The map server shares the travel information with the second user in response to the sharing request.

The map server obtains, in response to the sharing request, the travel information transmitted by the on-board terminal, and shares the travel information with the second user.

According to the method provided in this embodiment, the map server can communicate with the on-board map application and the on-board social application. When the map server receives the travel information transmitted by the on-board terminal by using the on-board map application and receives the sharing request transmitted by the on-board terminal by using the on-board social application, the map server shares the travel information with the second user based on indication of the sharing request. In this way, a function of sharing the travel information is provided for the on-board terminal, and a function of the on-board terminal is expanded.

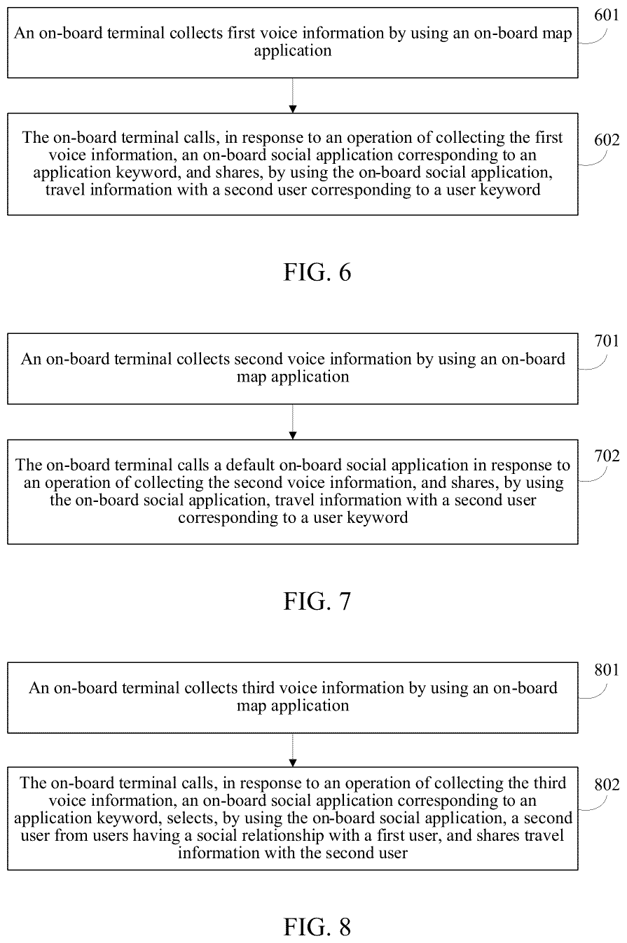

FIG. 6 is a flowchart of another travel information sharing method according to an embodiment of this application. This embodiment of this application is performed by an on-board terminal. As shown in FIG. 6, the method includes the following.

601: The on-board terminal collects first voice information by using an on-board map application.

The first voice information carries an operation keyword, an application keyword, and a user keyword. The operation keyword is configured for indicating performing an operation of sharing travel information, the application keyword is configured for indicating that the sharing is to be performed by using an on-board social application, and the user keyword is configured for indicating that a shared user is a second user. Therefore, the first voice information indicates that the travel information is shared with the second user by using the on-board social application. The second user has a social relationship with a first user logging into the on-board social application.

During driving, if a user wants to share the travel information with the second user in the on-board social application that has the social relationship with the first user, the user says the operation keyword, the application keyword, and the user keyword, so that the on-board terminal collects the first voice information carrying the operation keyword, the application keyword, and the user keyword.

602: The on-board terminal calls, in response to an operation of collecting the first voice information, an on-board social application corresponding to the application keyword, and shares, by using the on-board social application, the travel information with a second user corresponding to the user keyword.

After collecting the first voice information, the on-board terminal determines the on-board social application indicated by the application keyword in the first voice information, determines the second user indicated by the user keyword in the first voice information, calls the on-board social application, and shares the travel information with the second user by using the on-board social application.

According to the method provided in this embodiment, the on-board terminal runs the on-board map application and the on-board social application. The on-board map application provides the travel information of the on-board terminal, and the first user logs in to the on-board social application. When the first voice information is detected by using the on-board map application, the on-board terminal shares the travel information of the on-board terminal with the second user based on indications of the keywords in the first voice information. Therefore, the travel information of the on-board terminal can be shared with another user by saying the keywords. In this way, the travel information is shared quickly in an on-board scenario, the sharing process of the travel information is simplified, and efficiency of sharing the travel information is improved.

In addition, because in this embodiment, the travel information is shared with the second user through the on-board social application by using voice information indications, the user only needs to say the operation keyword, the application keyword, and the user keyword to share the travel information, so that a function of sharing the travel information based on voice is provided, and efficiency of human-computer interaction is improved.

FIG. 7 is a flowchart of another travel information sharing method according to an embodiment of this application. This embodiment of this application is performed by an on-board terminal. As shown in FIG. 7, the method includes the following.

701: The on-board terminal collects second voice information by using an on-board map application.

The second voice information carries an operation keyword and a user keyword. The operation keyword is configured for indicating performing an operation of sharing travel information, and the user keyword is configured for indicating that a shared user is a second user. Therefore, the second voice information indicates that the travel information is shared with the second user.

During driving, if a user wants to share the travel information with the second user in an on-board social application that has a social relationship with a first user, the user says the operation keyword and the user keyword, so that the on-board terminal collects the second voice information carrying the operation keyword and the user keyword.

702: The on-board terminal calls a default on-board social application in response to an operation of collecting the second voice information, and shares, by using the on-board social application, the travel information with a second user corresponding to the user keyword.

The on-board terminal runs at least one on-board social application. After collecting the second voice information, the on-board terminal determines the second user indicated by the user keyword in the second voice information, determines the default on-board social application in the at least one on-board social application, calls the on-board social application, and shares the travel information with the second user by using the on-board social application.

This embodiment of this application only uses an example of calling the default on-board social application to share the travel information. In another embodiment, the on-board terminal queries from historical sharing records, in response to an operation of collecting the second voice information, the on-board social application of the second user indicated by the user keyword, calls the on-board social application, and shares the travel information with the second user by using the on-board social application. The historical sharing records include at least one user of which the travel information is shared and an on-board social application of each user. In addition, in each sharing process, the travel information is shared with the user by using the on-board social application of the user. Therefore, during the sharing process, the on-board terminal queries the on-board social application of the second user from the historical sharing records.

According to the method provided in this embodiment, the on-board terminal runs the on-board map application and the on-board social application. The on-board map application provides the travel information of the on-board terminal, and the first user logs in to the on-board social application. When the second voice information is detected by using the on-board map application, the on-board terminal shares the travel information of the on-board terminal with the second user based on indications of the keywords in the second voice information. Therefore, the travel information of the on-board terminal can be shared with another user by saying the keywords. In this way, the travel information is shared quickly in an on-board scenario, the sharing process of the travel information is simplified, and efficiency of sharing the travel information is improved.

In addition, in this embodiment, the travel information is shared with the second user by using voice information indications, so that a function of sharing the travel information based on voice is provided, and efficiency of human-computer interaction is improved. Moreover, the user only needs to say the operation keyword and the user keyword, and the on-board terminal can automatically determine an on-board social application, and share the travel information with the second user based on the determined on-board social application, so that convenience of sharing the travel information is further improved.

FIG. 8 is a flowchart of another travel information sharing method according to an embodiment of this application. This embodiment of this application is performed by an on-board terminal. As shown in FIG. 8, the method includes the following.

801: The on-board terminal collects third voice information by using an on-board map application.

The third voice information carries an operation keyword and an application keyword. The operation keyword is configured for indicating performing an operation of sharing travel information, and the application keyword is configured for indicating that the sharing is to be performed by using an on-board social application. Therefore, the third voice information indicates that the travel information is shared by using the on-board social application.

During driving, if a user wants to share the travel information by using the on-board social application, the user says the operation keyword and the application keyword, so that the on-board terminal collects the third voice information carrying the operation keyword and the application keyword.

802: The on-board terminal calls, in response to an operation of collecting the third voice information, an on-board social application corresponding to the application keyword, selects, by using the on-board social application, a second user from users having a social relationship with a first user, and shares the travel information with the second user.

After collecting the third voice information, the on-board terminal determines the on-board social application indicated by the application keyword in the third voice information, calls the on-board social application, and shares the travel information with the second user by using the on-board social application.

In one embodiment, the second user is a default user among users that have the social relationship with the first user, or a user with which the travel information is shared last time, or the second user is a user randomly determined by the on-board terminal among users that have the social relationship with the first user, or the like. This is not limited in this embodiment.

In one embodiment, the on-board terminal displays a user selection interface by using the on-board social application. The user selection interface displays at least one user having the social relationship with the first user and a first keyword of each user. The first keyword is configured for indicating selecting the user. The on-board terminal shares the travel information with the second user in response to an operation of collecting a fourth voice information. The fourth voice information carries a first keyword of the second user.

After a user views at least one user displayed in the user selection interface and the first keyword of each user, the user determines the first keyword of the second user that the user wants to select and says the first keyword of the second user. When the fourth voice information including the first keyword is collected, the on-board terminal shares the travel information with the second user.

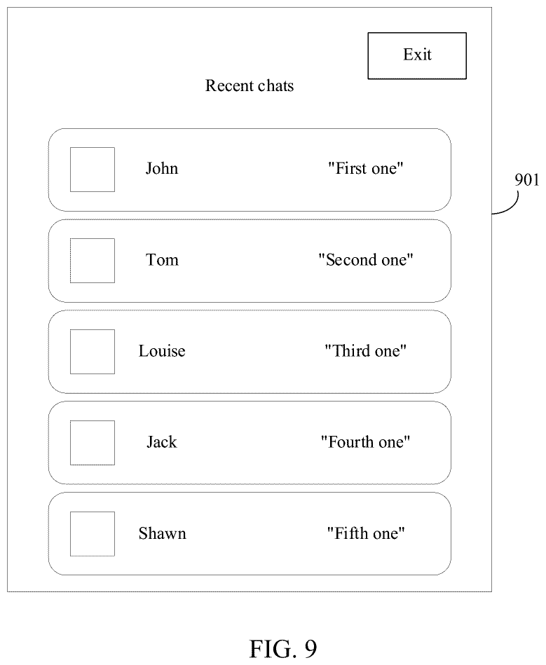

FIG. 9 is a schematic diagram of a user selection interface according to an embodiment of this application. As shown in FIG. 9, in a user selection interface 901, a plurality of users having the social relationship with the first user are displayed, that are, John, Tom, Louise, Jack, and Shawn, and a trigger words of each user are also displayed on the right of an interface. Trigger words for John are “first one”, trigger words for Tom are “second one”, trigger words for Louise are “third one”, trigger words for Jack are “fourth one”, and trigger words for Shawn are “fifth one”. For example, if the user wants to share travel information with Tom, the user says the trigger words “second one”. The trigger words of each user here are exemplary descriptions of the first keyword of each user.

In another embodiment, the on-board terminal displays a user selection interface by using an on-board social application. The user selection interface displays at least one user having the social relationship with the first user. The on-board terminal shares the travel information with the second user in response to a trigger operation on the second user.

According to the method provided in this embodiment, the on-board terminal runs the on-board map application and the on-board social application. The on-board map application provides the travel information of the on-board terminal, and the first user logs in to the on-board social application. When the second voice information is detected by using the on-board map application, the on-board terminal shares the travel information of the on-board terminal with the second user based on indications of the keywords in the second voice information. Therefore, the travel information of the on-board terminal can be shared with another user by saying the keywords. In this way, the travel information is shared quickly in an on-board scenario, the sharing process of the travel information is simplified, and efficiency of sharing the travel information is improved.

In addition, in this embodiment, the travel information is shared with the second user by using voice information indications, so that a function of sharing the travel information based on voice is provided, and efficiency of human-computer interaction is improved. Moreover, the user only needs to say the operation keyword and the application keyword, and the on-board terminal can automatically determine the second user, and share the travel information with the second user by using the on-board social application, so that convenience of sharing the travel information is further improved.

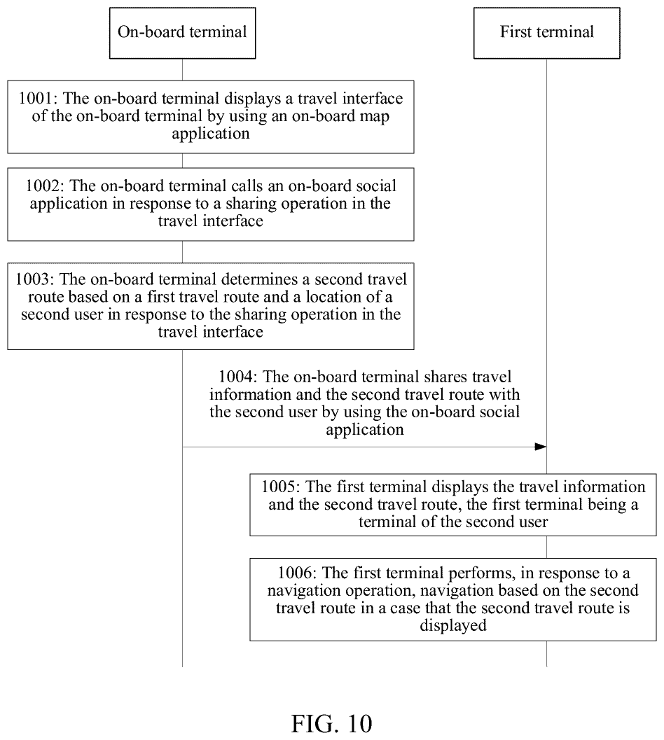

FIG. 10 is a flowchart of another travel information sharing method according to an embodiment of this application. This embodiment of this application is performed by an on-board terminal and a first terminal interactively. As shown in FIG. 10, the method includes the following.

1001: The on-board terminal displays a travel interface of the on-board terminal by using an on-board map application.

The on-board map application displays the travel interface, and the travel interface displays the travel information of the on-board terminal. The travel information includes a first travel route of the on-board terminal, and the first travel route is a route from a start point to an end point.

1002: The on-board terminal calls an on-board social application in response to a sharing operation in the travel interface.

1003: The on-board terminal determines a second travel route based on the first travel route and a location of a second user in response to the sharing operation in the travel interface.

When the sharing operation is detected, the on-board terminal determines the second travel route based on the first travel route and the location of the second user in response to the sharing operation. The second travel route is a route with the highest degree of overlap with the first travel route among candidate travel routes. The candidate travel route is a route of which a start point is at the location of the second user, and an end point is the same as an end point of the first travel route.

In other words, the on-board terminal plans, for the second user, the second travel route having the same end point as the first travel route, so that the second user performs subsequently navigation based on the second travel route planned by the on-board terminal.

1004: The on-board terminal shares the travel information and the second travel route with the second user by using the on-board social application.

1005: The first terminal displays the travel information and the second travel route, the first terminal being a terminal of the second user.

The first terminal runs a social application, and the social application in the first terminal and the on-board social application in the on-board terminal are of the same type. A user of the first terminal logging in to the social application is the second user, and the second user is an account logging in to the social application.

After receiving the travel information and the second travel route, the first terminal displays the travel information and the second travel route, so that a user using the first terminal views the travel information shared by the on-board terminal, learns a travel status of the on-board terminal, and views the second travel route planned by the on-board terminal for the user.

1006: The first terminal performs, in response to a navigation operation, navigation based on the second travel route in a case that the second travel route is displayed.

In a case that the first terminal displays the second travel route, if the user wants to travel based on the second travel route planned by the on-board terminal for the user, the user performs the navigation operation for the second travel route, and the first terminal performs navigation based on the second travel route in response to the navigation operation.

According to the method in this embodiment, the travel information of the on-board terminal includes the first travel route of the on-board terminal. While sharing the travel information with the second user, the on-board terminal also plans, for the second user, the second travel route having the same end point as the first travel route based on the location of the second user and the first travel route, and shares the second travel route with the second user, so that a function of assisting in route planning is provided and sharing content is enriched.

Based on the foregoing embodiment, after sharing the travel information with the second user, the on-board terminal further performs at least one of the following:

(1) The on-board terminal receives the location of the second user. The location of the second user is a location of the terminal logged in by the second user. The on-board terminal displays a location of the on-board terminal and the location of the second user in the travel interface of the on-board terminal.

After the on-board terminal shares the travel information with the second user, the terminal logged in by the second user may also share the location of the second user with the on-board terminal. Therefore, the on-board terminal displays the location of the on-board terminal and the location of the second user in the travel interface at the same time, so that the user views a distance between the location of the on-board terminal and the location of the second user. In this way, display content is enriched, a display effect is improved, and a personalized expression of the travel interface is achieved.

(2) The on-board terminal shares updated travel information with the second user in a case that the travel information is updated.

In one embodiment, the travel information includes a travel route. The on-board terminal shares an updated travel route with the second user in a case that the travel route is updated. The travel route is a planned travel route, and the on-board terminal further updates the travel route. If the travel route is updated, the on-board terminal shares an updated travel route with the second user, so that the second user can synchronously update the travel route, to ensure that the travel route on the on-board terminal is consistent with the travel route obtained by the second user, so as to avoid an information gap when the travel route is updated.

There are a number of situations in which the travel route is updated. In one embodiment, the on-board terminal updates, in response to a switch operation on a route requirement, the travel route to a travel route that satisfies a switched route requirement. The route requirement represents a route planning preference. In one embodiment, the on-board terminal updates, in response to a modification operation on a waypoint, the travel route to a travel route passing by a modified waypoint. For example, after the waypoint is added, a current travel route is updated to a travel route passing by the waypoint. For example, after the waypoint is deleted, the current travel route is updated to a travel route not passing by the waypoint. In one embodiment, the on-board terminal updates, in response to a route switch operation, the travel route to a travel route indicated by the route switch operation. In one embodiment, the travel route of the on-board terminal includes an end point, the on-board terminal updates the travel route to a travel route from a current location of the on-board terminal to the end point in a case that the on-board terminal deviates from the travel route. In one embodiment, after receiving a travel route dynamically recommended by a map server, the on-board terminal updates the current travel route to the dynamically recommended travel route.

In another embodiment, the travel information includes a moving progress, and the moving progress is a progress of the on-board terminal moving along the travel route. The on-board terminal obtains an updated moving progress every first duration, and shares the updated moving progress with the second user. The moving progress includes the location of the on-board terminal, a passing route status, estimated time to arrive at the end point of the travel route, a distance to the end point, a navigation status, and the like.

In one embodiment, the on-board terminal determines a location of the on-board terminal on the travel route every second duration based on the location of the on-board terminal and the travel route. In one embodiment, the second duration is shorter than the first duration. The on-board terminal updates the moving progress of the on-board terminal based on the location of the on-board terminal on the travel route.

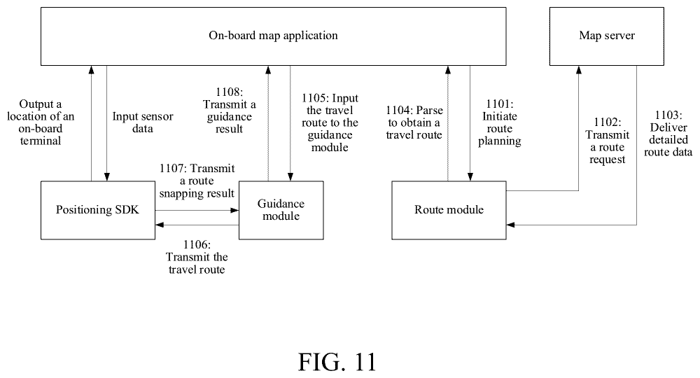

FIG. 11 is a flowchart of a moving progress updating method according to an embodiment of this application. As shown in FIG. 11, an on-board map application obtains sensor data and inputs the data to a positioning SDK. The sensor data includes a moving speed, a triaxial attitude angle, an acceleration, and the like of the on-board terminal. The positioning SDK determines a location of the on-board terminal based on the sensor data, and the on-board map application uses the location of the on-board terminal to plan a travel route. The method includes:

1101: The on-board map application obtains the location of the on-board terminal from the positioning SDK and initiates route planning to a route module.

1102: The route module requests, from a map server, detailed route data from the location of the on-board terminal to the end point.

1103: The map server delivers the detailed route data to the route module in response to a route request.

1104: The route module parses the detailed route data to obtain the travel route, including a route identifier of the travel route, a length of the travel route, and shape points of the travel route. The shape points are a series of location points forming the travel route in an electronic map.

1105: The on-board map application inputs the travel route to a guidance module. For example, the guidance module is an RGS of the on-board terminal.

1106: The guidance module transmits the travel route to the positioning SDK.

1107: The positioning SDK determines a route snapping result based on the location of the on-board terminal and the travel route. The route snapping result indicates the location of the on-board terminal on the travel route. The route snapping result is represented by an index of the shape points on the travel route. The positioning SDK transmits the route snapping result to the guidance module.

1108: The guidance module performs guidance calculation based on the route snapping result to obtain a guidance result. The guidance result includes ahead information of an ahead maneuver vehicle, estimated arrival time, a navigation status, and the like of the on-board terminal. The ahead maneuver information includes an ahead turning status, ahead traffic status information, and the like. The guidance calculation means a process in which the RGS calculates a guidance result based on the route snapping result.

(3) The on-board terminal transmits, in a case that the on-board terminal ends a current trip, a trip end message to a terminal logged in by a second user. The trip end message is configured for prompting the on-board terminal to end the current trip.

The end of the current trip includes a case in which the on-board terminal exits navigation or the on-board terminal arrives at an end point and the like.

(4) The on-board terminal transmits, in response to a sharing cancel operation, a sharing cancel message to the terminal logged in by the second user. The sharing cancel message is configured for prompting the on-board terminal to cancel sharing of the travel information.

In this embodiment, the on-board terminal executes a sharing logic of the travel information once when a sharing operation is detected each time. After initiating the sharing of the travel information, if the on-board terminal exits route planning, exits route navigation, or arrives at a destination, a travel information sharing process is completed. If the on-board terminal performs next route planning or next route navigation anew, a new sharing process may be triggered after the sharing operation is detected again to share travel information of this time. After initiating the sharing of the travel information, if the current travel route is updated, for example, a route planning preference is switched, a waypoint is added or deleted, or the on-board terminal deviates from the route, a new sharing process may not be triggered, but the travel information may be updated based on the original sharing process. After initiating the sharing of the travel information, if the on-board terminal initiates new route planning or new route navigation anew, for example, an end point is changed, it is needed to end the current sharing process and trigger a new sharing process anew to share the current travel information anew.

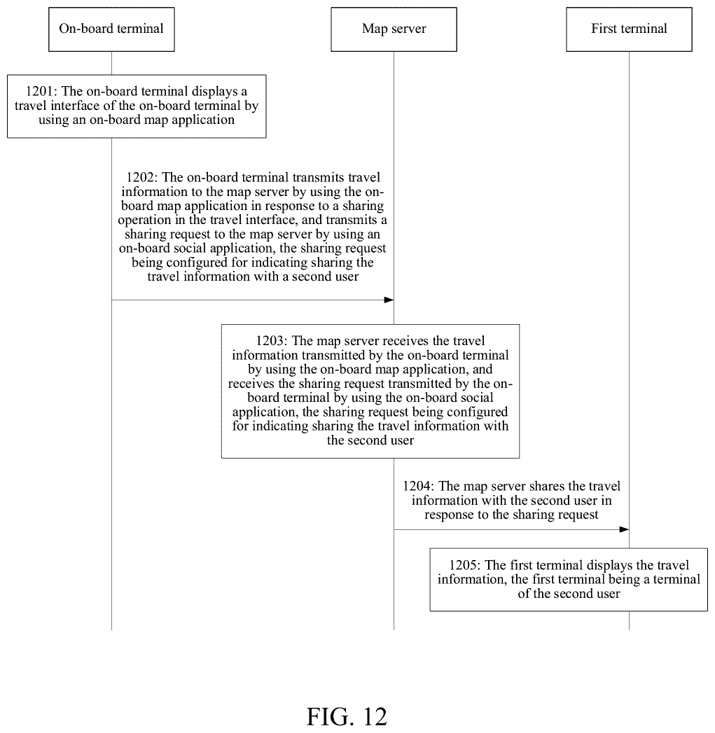

FIG. 12 is a flowchart of another travel information sharing method according to an embodiment of this application. This embodiment of this application is performed by an on-board terminal, a map server, and a first terminal. As shown in FIG. 12, the method includes the following.

1201: The on-board terminal displays a travel interface of the on-board terminal by using an on-board map application.

In one embodiment, the on-board terminal displays a route planning interface by using the on-board map application. The route planning interface displays a planned travel route. A sharing operation is configured for indicating sharing a travel route, that is, sharing the planned travel route.

The travel route is shared in a route planning scenario. The route planning scenario is a scenario in which a travel route from a start point to an end point is planned before a trip begins. When the travel route is planned, a route planning preference and route planning result are determined in the route planning interface, or a route overview or route details of the travel route are viewed. The route planning result means that a travel route planned by route planning based on the route planning preference (which may be default).

FIG. 13 is a schematic diagram of a route planning interface according to an embodiment of this application. As shown in FIG. 13, the route planning interface 1301 includes a planned travel route and route overviews of a candidate route 1, a candidate route 2, and a candidate route 3. The route planning interface 1301 further includes a “travel sharing” option 1302 and an “exit” option. The “travel sharing” option 1302 is configured for triggering a sharing operation on the travel route, and the “exit” option is configured for triggering exiting the route planning interface.

In another embodiment, the on-board terminal displays a route navigation interface by using the on-board map application. The route navigation interface displays a travel route being navigated to. The sharing operation is configured for indicating sharing the travel route, that is, sharing the travel route being navigated to.

The travel route is shared in a route navigation scenario. The route navigation scenario is a scenario in which navigation is performed based on the planned travel route, and the on-board terminal is traveling along the travel route.

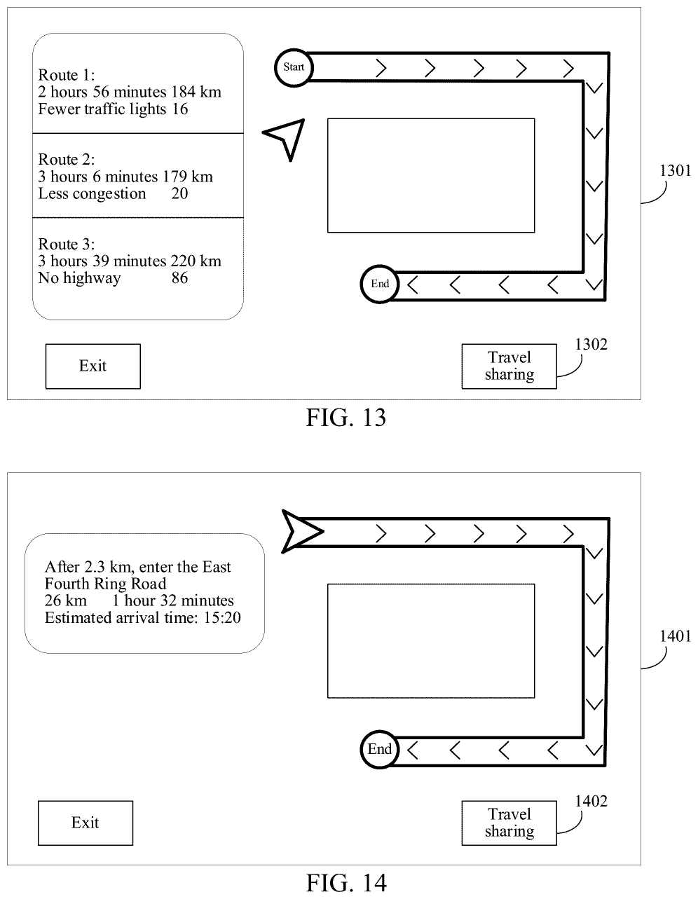

FIG. 14 is a schematic diagram of a route navigation interface according to an embodiment of this application. As shown in FIG. 14, the route navigation interface 1401 includes a travel route being navigated to and current navigation information. The route navigation interface 1401 further includes a “travel sharing” option 1402 and an “exit” option. The “travel sharing” option 1402 is configured for triggering a sharing operation on the travel route, and the “exit” option is configured for triggering exiting the route navigation interface.

In this embodiment, scenarios for sharing the travel route are classified into the route planning scenario and the route navigation scenario, so that fine-grained control of the scenarios is implemented and flexibility of sharing travel information is improved.

1202: The on-board terminal transmits travel information to the map server by using the on-board map application in response to the sharing operation in the travel interface, and transmits a sharing request to the map server by using an on-board social application, the sharing request being configured for indicating sharing the travel information with a second user.

The on-board terminal transmits the travel information to the map server by using the on-board map application in response to the sharing operation, calls the on-board social application, and transmits the sharing request to the map server by using the on-board social application. In one embodiment, the sharing request carries a user identifier of the second user. The sharing request is configured for indicating sharing the travel information with the second user indicated by the user identifier.

In one embodiment, the travel information includes a route identifier of a travel route being navigated to. The on-board terminal transmits the route identifier to the map server by using the on-board map application. The sharing request is configured for indicating sharing the travel route indicated by the route identifier with the second user. In one embodiment, the travel information further includes a moving progress. The moving progress is a progress of the on-board terminal moving along the travel route. The on-board terminal transmits the route identifier and the moving progress to the map server by using the on-board map application. The sharing request is configured for indicating sharing the travel route indicated by the route identifier and the moving progress with the second user.

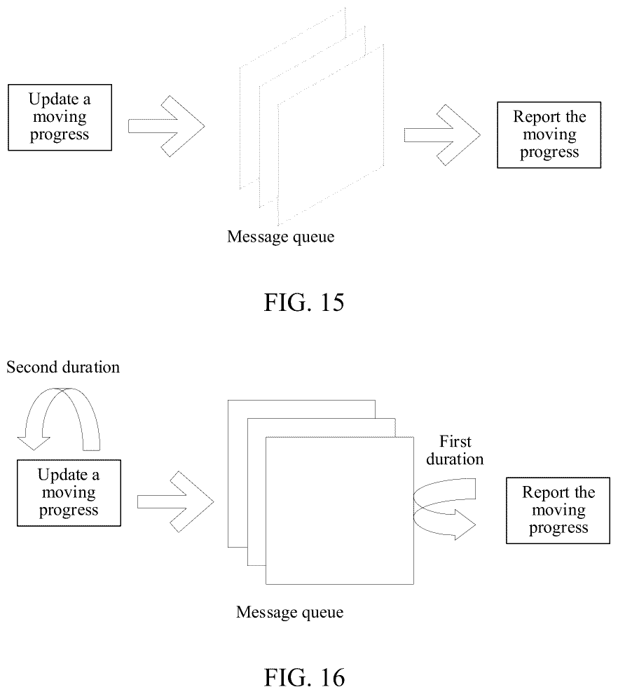

In one embodiment, the on-board terminal obtains an updated moving progress every first duration, and transmits the updated moving progress to the map server. In one embodiment, the on-board terminal updates the moving progress every the first duration, and transmits the updated moving progress to the map server after obtaining the updated moving progress. In other words, the on-board terminal reports the moving progress to the map server based on update frequency of the moving progress. As shown in FIG. 15, the on-board terminal updates the moving progress, adds the updated moving progress to a message queue, and reports a latest moving progress in the message queue to the map server.

In one embodiment, the on-board terminal updates the moving progress every second duration, obtains the updated moving progress every first duration, and transmits the updated moving progress to the map server. The second duration is shorter than the first duration. To be specific, frequency of reporting the moving progress is lower than the frequency of updating the moving progress. As shown in FIG. 16, the on-board terminal updates the moving progress every the second duration, adds the updated moving progress to a message queue, obtains a latest moving progress from the message queue every first duration, and reports the obtained moving progress to the map server. In this method, considering that excessively high the frequency of reporting the moving progress may cause data accumulation, resulting in reduced real-time performance of the moving progress, the reporting frequency lower than the update frequency is used for reporting, so that efficiency of reporting the moving progress is ensured. For example, the first duration is one minute, and the second duration is one second.

1203: The map server receives the travel information transmitted by the on-board terminal by using the on-board map application, and receives the sharing request transmitted by the on-board terminal by using the on-board social application, the sharing request being configured for indicating sharing the travel information with the second user.

1204: The map server shares the travel information with the second user in response to the sharing request.

The map server obtains, in response to the sharing request, the travel information transmitted by the on-board terminal, and shares the travel information with the second user.

In one embodiment, the map server generates a sharing message. The sharing message is associated with a mini program interface including the travel information, and the sharing message is configured for accessing the mini program interface including the travel information when being triggered. The map server shares the sharing message to the second user. In this embodiment, the map server shares the sharing message with the second user. Therefore, the sharing message is triggered to access the mini program interface including the travel information without installing a map application on a terminal of the second user, so that convenience of sharing the travel information is improved.

In one embodiment, after the map server shares the sharing message with the second user, the method further includes any of the following:

(1) The map server updates the mini program interface based on received updated travel information, an updated mini program interface including the updated travel information.

(2) The map server updates the mini program interface based on a received trip end message, the updated mini program interface including the trip end message, and the trip end message being configured for prompting the on-board terminal to end a current trip.

(3) The map server updates the mini program interface based on a received sharing cancel message, the updated mini program interface including the sharing cancel message, and the sharing cancel message being configured for prompting the on-board terminal to cancel sharing of the travel information.

(4) The map server updates the mini program interface in a case that duration since the travel information is received last time reaches third duration, the updated mini program interface including a sharing interruption message, and the sharing interruption message being configured for prompting an interruption in sharing the travel information.

1205: The first terminal displays the travel information, the first terminal being a terminal of the second user.

The first terminal displays the travel information by using a map application, or the first terminal displays the mini program interface including the travel information.

In one embodiment, that the first terminal displays the travel information includes any of the following:

(1) The first terminal displays a planned travel route.

(2) The first terminal displays a travel route being navigated to and a moving progress, the moving progress being a progress of a terminal logged in by a third user moving along the travel route.

(3) The first terminal displays at least one waypoint on the travel route.

(4) The first terminal displays at least one road section on the travel route based on a traffic status of the at least one road section on the travel route. For example, road sections with different congestion status are represented by different colors.

(5) The first terminal displays the user identifier of the second user at a location of the terminal of the second user.

(6) The first terminal displays a location of the on-board terminal.

(7) The first terminal displays time information when the travel information is last updated.

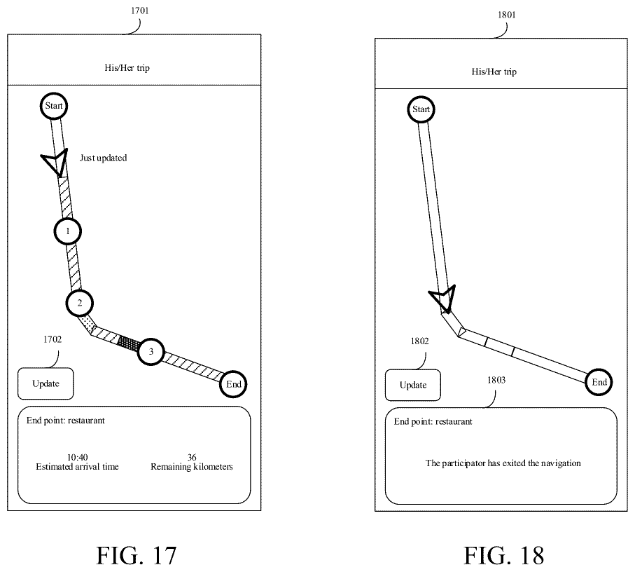

FIG. 17 is a schematic diagram of travel information according to an embodiment of this application. As shown in FIG. 17, the travel information is displayed in a mini program interface 1701. The travel information includes a travel route from a start point to an end point, a location of an on-board terminal, and time information when the travel information is last updated. The travel information further includes three waypoints in the travel route, and the travel route includes a plurality of road sections. Different shadow effects are used in FIG. 17 to indicate a degree of congestion of the road sections. The travel information further includes the end point of the travel route, estimated arrival time, and remaining kilometers. The mini program interface 1701 further includes an “update” option 1702. The “update” option 1702 is configured for updating travel information currently displayed in the mini program interface 1701. A vehicle icon, an avatar picture of a first user, or the like is displayed at the location of the on-board terminal. The mini program interface 1701 further displays a location of the second user. If the on-board terminal is expected to arrive at the end point on the same day, the estimated arrival time may be displayed in the mini program interface 1701. If the on-board terminal is expected to arrive at the end point on the next day, “tomorrow” and the estimated arrival time may be displayed in the mini program interface 1701. If the on-board terminal is expected to arrive at the end point on the third day, “the day after tomorrow” and the estimated arrival time may be displayed in the mini program interface 1701. If the on-board terminal is expected to arrive at the end point three days later, an estimated arrival date and the estimated arrival time may be displayed in the mini program interface 1701.

Based on the foregoing embodiment, after displaying the travel information, the on-board terminal further performs at least one of the following.

(1) The travel information includes travel information of a terminal logged in by the first user and a second travel route. The second travel route is a travel route recommended to the second user. The on-board terminal performs, in response to a navigation operation, navigation based on the second travel route in a case that the second travel route is displayed.

(2) The on-board terminal displays, in a case that a trip end message for the travel information is received, the trip end message, the trip end message being configured for prompting the terminal logged in by the first user to end a current trip.

The on-board terminal displays, in a case that a trip end message for the travel information is received, the trip end message, and cancels the displaying at least one road section on the travel route based on a traffic status of the at least one road section on the travel route. For example, before the trip is ended, colored lines are used to indicate road sections with different degrees of congestion. After the trip ended, all road sections are switched to gray.

FIG. 18 is a schematic diagram of another travel information according to an embodiment of this application. As shown in FIG. 18, last updated travel information is displayed in a mini program interface 1801. The mini program interface 1801 further includes an “update” option 1802. The “update” option 1802 is configured for updating travel information currently displayed in the mini program interface 1801. The mini program interface 1801 further includes a trip end message 1803. The trip end message 1803 includes prompt text “The participator has exited the navigation”.

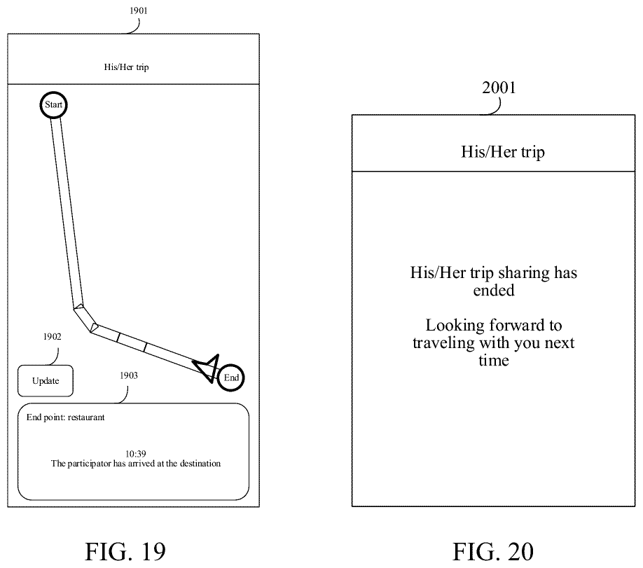

FIG. 19 is a schematic diagram of another travel information according to an embodiment of this application. As shown in FIG. 19, last updated travel information is displayed in a mini program interface 1901. The travel information indicates that the on-board terminal already arrives at an end point of a travel route. The mini program interface 1901 further includes an “update” option 1902. The “update” option 1902 is configured for updating travel information currently displayed in the mini program interface 1901. The mini program interface 1901 further includes a trip end message 1903. The trip end message 1903 includes prompt text “The participator has arrived at the destination”.

In one embodiment, in a case that duration since the trip end message is received reaches fourth duration, display of the travel information is cancelled. FIG. 20 is a schematic diagram of another travel information according to an embodiment of this application. As shown in FIG. 20, in a mini program interface 2001, display of travel information is cancelled and prompt text “His/Her trip sharing has ended, looking forward to traveling with you next time” is displayed.

(3) The on-board terminal displays a sharing cancel message in a case that the sharing cancel message for the travel information is received, the sharing cancel message being configured for prompting the terminal logged in by the third user to cancel sharing of the travel information.

In one embodiment, in a case that duration since the sharing cancel message is received reaches fifth duration, display of the travel information is cancelled.

(4) The on-board terminal cancels display of the travel information in a case that duration since the travel information is obtained last time reaches the second duration, and displays a sharing interruption message, the sharing interruption message being configured for prompting an interruption in sharing the travel information.

In one embodiment, the first terminal is a non-on-board terminal. The first terminal displays the sharing message transmitted by the map server in a social application, and displays, in response to a trigger operation on the sharing message, the mini program interface including the travel information.

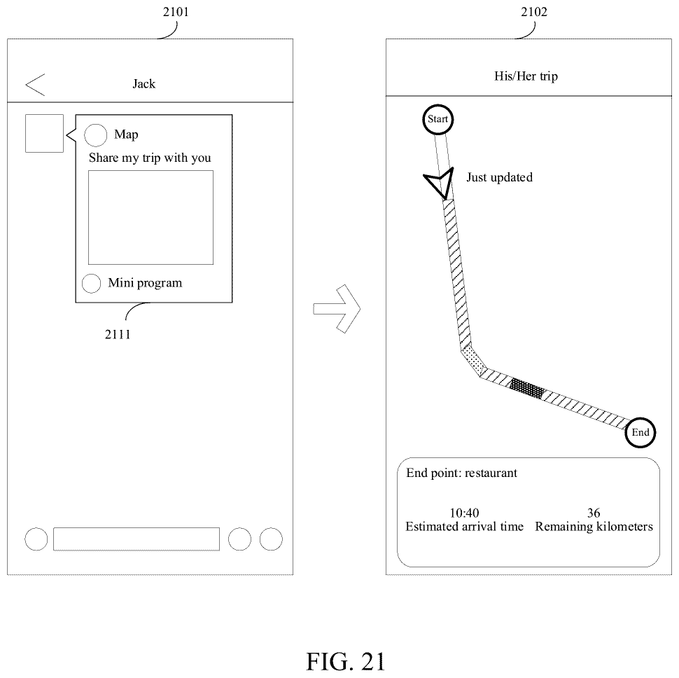

FIG. 21 is a schematic diagram of a travel information display method according to an embodiment of this application. As shown in FIG. 21, the first terminal displays an interactive interface 2101 of a social application. The interactive interface 2101 includes a sharing message 2111 transmitted by a friend. When a user clicks/taps on the sharing message 2111, the first terminal jumps to a mini program interface 2102. The mini program interface 2102 includes travel information shared by the friend, such as a travel route, a location of an on-board terminal of the friend, an end point, estimated arrival time, and remaining kilometers.

In one embodiment, the first terminal is an on-board terminal, and a manner of the first terminal in displaying the travel information is as shown in an embodiment of FIG. 21 below.

According to the method provided in this embodiment, the on-board terminal runs the on-board map application and the on-board social application. The on-board map application provides the travel information of the on-board terminal, and the first user logs in to the on-board social application. When the sharing operation configured for indicating sharing the travel information is detected by using the on-board map application, the on-board terminal shares the travel information of the on-board terminal with the second user that has the social relationship with the first user. Therefore, the travel information of the on-board terminal can be shared with another user by triggering the sharing operation. In this way, the travel information is shared quickly in an on-board scenario, the sharing process of the travel information is simplified, and efficiency of sharing the travel information is improved.

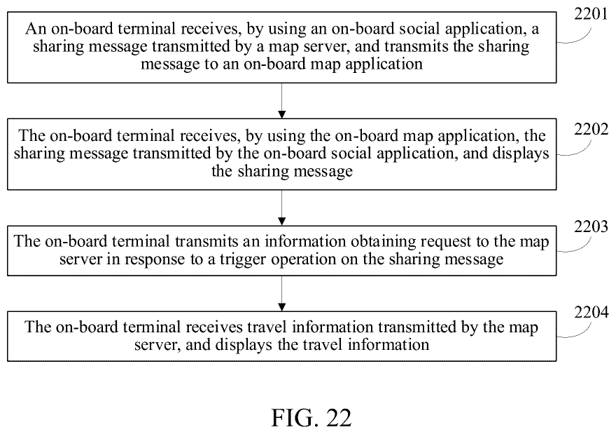

FIG. 22 is a flowchart of another travel information sharing method according to an embodiment of this application. This embodiment of this application is performed by an on-board terminal. As shown in FIG. 22, the method includes the following.

2201: The on-board terminal receives, by using an on-board social application, a sharing message transmitted by a map server, and transmits the sharing message to an on-board map application.

The on-board terminal runs the on-board map application and the on-board social application. The on-board social application can obtain the sharing message and provide the sharing message for the on-board map application. The sharing message is associated with travel information. The travel information is shared by a third user to a fourth user. The fourth user is a user of the on-board terminal logging into the on-board social application, and the third user has a social relationship with the fourth user.

2202: The on-board terminal receives, by using the on-board map application, the sharing message transmitted by the on-board social application, and displays the sharing message.

2203: The on-board terminal transmits an information obtaining request to the map server in response to a trigger operation on the sharing message.

If a user wants to view the travel information associated with the sharing message, the user performs the trigger operation on the sharing message. The on-board terminal transmits the information obtaining request to the map server in response to the trigger operation on the sharing message. The information obtaining request is configured for requesting to obtain the travel information associated with the sharing message.

2204: The on-board terminal receives the travel information transmitted by the map server, and displays the travel information.

In the foregoing operation 2203 and operation 2204, the on-board terminal displays, in response to the trigger operation on the sharing message, the travel information associated with the sharing message.

In one embodiment, that the on-board terminal displays the travel information includes any of the following:

(1) The on-board terminal displays a planned travel route.

(2) The on-board terminal displays a travel route being navigated to and a moving progress, the moving progress being a progress of a terminal logged in by a third user moving along the travel route.

(3) The on-board terminal displays at least one waypoint on the travel route.

(4) The on-board terminal displays at least one road section on the travel route based on a traffic status of the at least one road section on the travel route.

(5) The on-board terminal displays a user identifier of the third user at a location of the terminal of the third user.

(6) The on-board terminal displays a location of the on-board terminal.

(7) The on-board terminal displays time information when the travel information is last updated.

Based on the foregoing embodiment, after displaying the travel information, the on-board terminal further performs at least one of the following.

(1) The travel information includes travel information of the terminal logged in by the third user and a second travel route. The second travel route is a travel route recommended to the fourth user. The on-board terminal performs, in response to a navigation operation, navigation based on the second travel route in a case that the second travel route is displayed.

(2) The on-board terminal displays, in a case that a trip end message for the travel information is received, the trip end message, the trip end message being configured for prompting the terminal logged in by the third user to end a current trip.

In one embodiment, in a case that duration since the trip end message is received reaches fourth duration, display of the travel information is cancelled.

(3) The on-board terminal displays a sharing cancel message in a case that the sharing cancel message for the travel information is received, the sharing cancel message being configured for prompting the terminal logged in by the third user to cancel sharing of the travel information.

In one embodiment, in a case that duration since the sharing cancel message is received reaches fifth duration, display of the travel information is cancelled.

(4) The on-board terminal cancels display of the travel information in a case that duration since the travel information is obtained last time reaches third duration, and displays a sharing interruption message, the sharing interruption message being configured for prompting an interruption in sharing the travel information.

(5) The on-board terminal replaces the currently displayed travel information with updated travel information in a case that the updated travel information is received.

In one embodiment, the travel information includes a travel route. A currently displayed travel route is replaced with updated travel route in a case that the updated travel route is received.

In one embodiment, the updated travel route is obtained based on a switch operation on a route requirement, and the updated travel route satisfies a switched route requirement. In one embodiment, the updated travel route is obtained based on a modification operation on a waypoint, and the updated travel route passes by a modified waypoint. In one embodiment, the updated travel route is obtained based on a route switch operation, and the updated travel route is a travel route indicated by the route switch operation. In one embodiment, the travel route includes an end point, and the travel route is updated when the terminal of the third user deviates from the travel route. An updated travel route is a travel route from a current location of the terminal of the third user to the end point.

In one embodiment, the travel information includes the travel route and a moving progress. The moving progress is a progress of the terminal of the third user moving along the travel route. A currently displayed moving progress is replaced with an updated moving progress in a case that the updated moving progress is received. The terminal of the third user obtains the updated moving progress every first duration, and shares the updated moving progress with the fourth user.

In one embodiment, the terminal of the third user determines a location of the terminal on the travel route based on the current location of the terminal and the travel route every second duration, and updates the moving progress of the terminal based on the location of the terminal on the travel route. In one embodiment, the second duration is shorter than the first duration.

According to the method provided in this embodiment, the on-board terminal runs the on-board map application and the on-board social application. The on-board map application provides travel information for the on-board terminal. The fourth user logs into the on-board social application. When the sharing message is obtained, the on-board social application provides the sharing message for the on-board map application, so that the on-board terminal displays the sharing message by using the on-board map application. When the sharing message is triggered, the travel information associated with the sharing message is displayed. In this way, the travel information of the third user is shared to the fourth user, and the user can view, on the on-board terminal, the travel information shared by a friend, so that a function of the on-board terminal is expanded, and travel information that can be displayed on the on-board terminal is enriched.

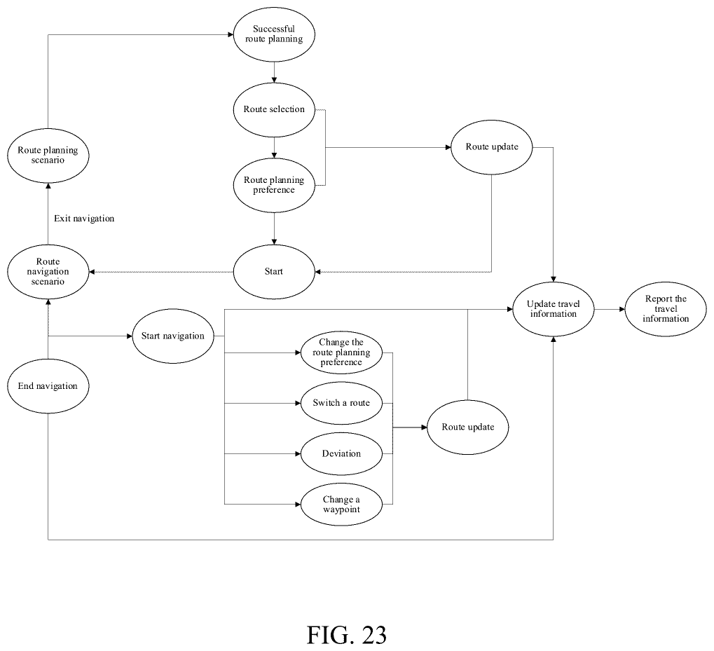

A state machine is used to manage states of the on-board terminal in various scenarios. FIG. 23 is a schematic diagram of state management of an on-board terminal according to an embodiment of this application. As shown in FIG. 23, the on-board terminal includes a route planning scenario and a route navigation scenario, and has the following four states. (1) Successful route planning: It represents a default state for entering a route planning scenario. If the planning fails, the route planning scenario may not be entered. (2) Route selection: It represents a state after the route planning successful. (3) Route planning preference: Switching the route planning preference means changing the route planning preference, for example, the route planning preference is changed from “highway avoidance” to “highway first”, so that the route is triggered to be planned anew. (4) Route update: It represents a route change state and may be entered whenever the route is switched. After the route is updated, a user enters the route navigation scenario by performing a navigation operation. The route navigation scenario includes two states: a start navigation state and an end navigation state. In the start navigation state, operations such as user deviation, changing the route planning preference, switching a route, and changing a waypoint may trigger the route update. After the route is updated, a travel information update state may be entered, and then travel information is reported.

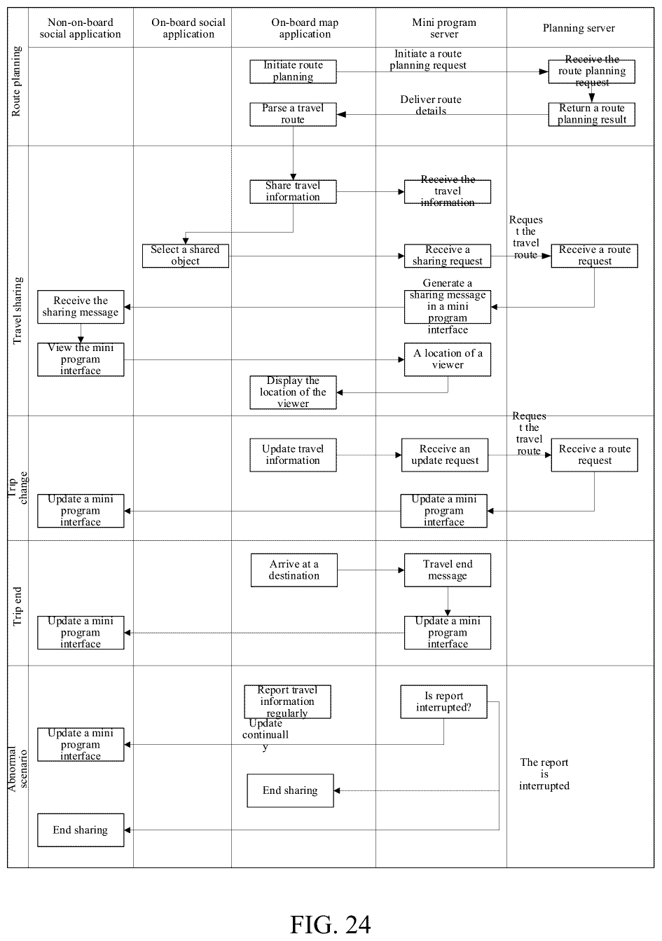

FIG. 24 is a flowchart of another travel information sharing method according to an embodiment of this application. As shown in FIG. 24, the method includes five scenarios: a route planning scenario, a travel sharing scenario, a trip change scenario, a trip end scenario, and an abnormal scenario. A map server includes a mini program server and a planning server.

(i) Route planning: It is initiated by an on-board map application. The on-board map application initiates a route planning request to the planning server. After the planning is completed, the planning server delivers a route planning result. The route planning result represents planned route details, and the route details include a route identifier.

(ii) Travel sharing: After the route planning is completed, a user is in a route planning scenario or a route navigation scenario and performs a sharing operation. First, the on-board map application reports travel information to the mini program server. Then, the on-board map application calls a user selection interface of an on-board social application on the on-board terminal. The user selects a shared user, and the on-board social application transmits a sharing request to the mini program server. The mini program server requests a travel route from the planning server, and the planning server transmits the travel route to the mini program server. The mini program server generates a mini program interface and a sharing message based on the travel route and a travel progress, and then transmits the sharing message to a non-on-board social application, so that the sharing message is pushed to the selected shared user, and the shared user clicks/taps the sharing message and then views the mini program interface.

(iii) Trip change: The travel route is changed during traveling due to operations such as changing a route preference, adding/deleting a waypoint, or changing a destination. The on-board map application reports a route identifier and a moving progress indicated by an updated travel route to a mini program backend. The mini program server requests a travel route indicated by the route identifier from the planning server based on the route identifier. The planning server transmits the travel route to the mini program server. The mini program server updates the mini program interface based on the updated travel route and travel progress, so that the non-on-board social application synchronously updates the mini program interface.

(iv) Trip end: The trip ends includes cases in which the user arrives at a destination, actively exits navigation, ends sharing, and the like. An example in which the user arrives at the destination is used. After the user arrives at the destination, the on-board map application reports a travel end message to the mini program server, and the mini program server updates the mini program interface based on the travel end message, so that the non-on-board social application synchronously update the mini program interface.

(vi) Abnormal scenario: When duration since the on-board map application reports travel information last time is excessively long, and the mini program server detects that the duration since the on-board map application reports the travel information last time reaches third duration, if it is determined that the report is interrupted, the mini program interface is updated, so that the mini program interface displays the travel end message.

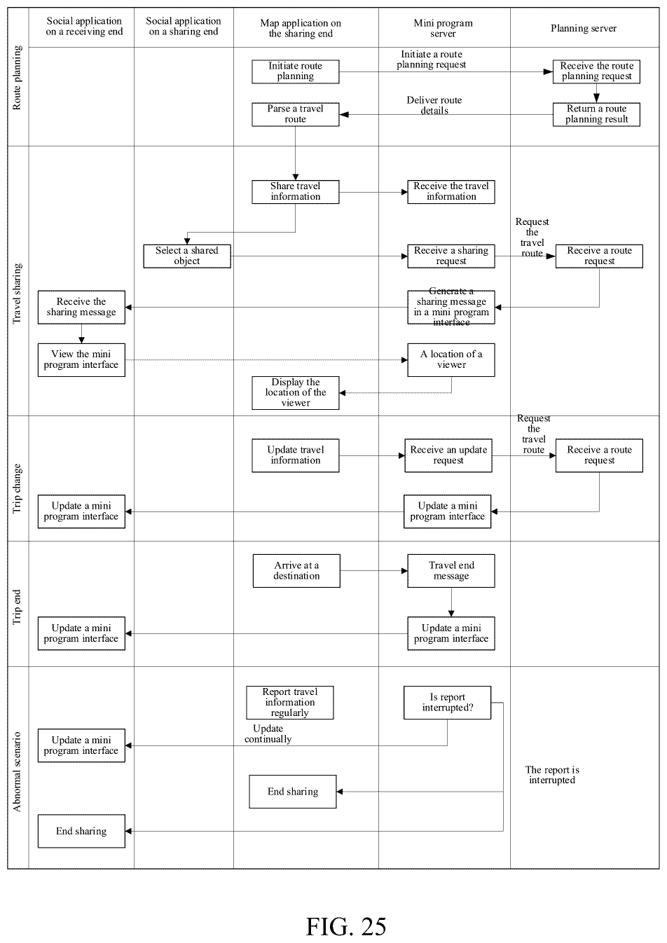

In FIG. 24, only an example in which the on-board terminal shares the travel information with the non-on-board terminal is used for description. In another embodiment, as shown in FIG. 25, a sharing end shares the travel information with a receiving end. The sharing end is the on-board terminal or the non-on-board terminal, and the receiving end is the on-board terminal or the non-on-board terminal.

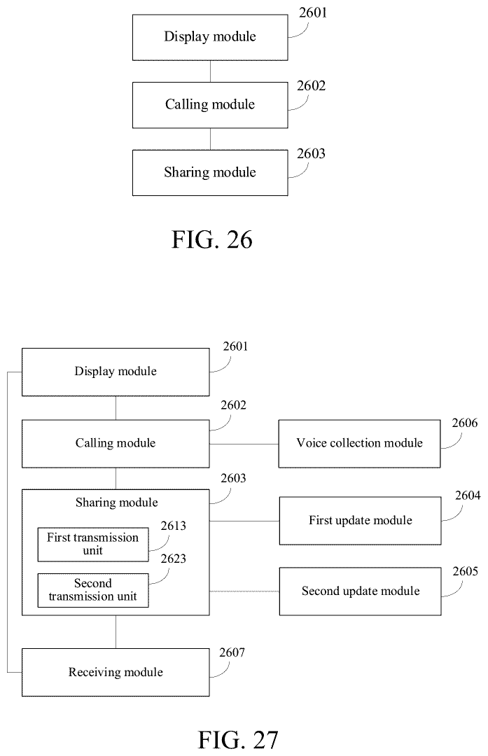

FIG. 26 is a schematic diagram of a structure of a travel information sharing apparatus according to an embodiment of this application. The apparatus is used in an on-board terminal. As shown in FIG. 26, the apparatus includes: a display module 2601, configured to display a travel interface of the on-board terminal by using an on-board map application, the travel interface displaying current travel information of the on-board terminal; a calling module 2602, configured to call an on-board social application in response to a sharing operation in the travel interface, the sharing operation being configured for indicating sharing the travel information; and a sharing module 2603, configured to share, by using the on-board social application, the travel information with a second user associated with a first user. The first user is a user of the on-board terminal logging into the on-board social application, and the second user is any user having a social relationship with the first user.

According to the travel information sharing apparatus provided in this embodiment, the on-board terminal runs the on-board map application and the on-board social application. The travel interface displayed by the on-board map application provides the current travel information of the on-board terminal, and the first user logs in to the on-board social application. When the sharing operation configured for indicating sharing the travel information is detected by using the on-board map application, the on-board terminal calls the on-board social application to share the travel information of the on-board terminal with the second user that has the social relationship with the first user. Therefore, the travel information of the on-board terminal can be shared with another user by triggering the sharing operation. In this way, the travel information of the on-board terminal is shared quickly in an on board scenario, the sharing process of the travel information by the on-board terminal is simplified, and efficiency of sharing the travel information by the on-board terminal is improved.

In one embodiment, referring to FIG. 27, the sharing module 2603 is further configured to share updated travel information with the second user in a case that the travel information is updated.

In one embodiment, referring to FIG. 27, the sharing module 2603 is configured to implement at least one of the following: the travel information including a travel route, sharing an updated travel route with the second user in a case that the travel route is updated; or the travel information including a moving progress, and the moving progress is a progress of the on-board terminal moving along the travel route, obtaining an updated moving progress every first duration, and sharing the updated moving progress with the second user.

In one embodiment, referring to FIG. 27, the travel information includes the travel route. The apparatus further includes a first update module 2604, configured to implement at least one of the following: updating, in response to a switch operation on a route requirement, the travel route to a travel route that satisfies a switched route requirement; updating, in response to a modification operation on a waypoint, the travel route to a travel route passing by a modified waypoint; updating, in response to a route switch operation, the travel route to a travel route indicated by the route switch operation; or the travel route including an end point, updating the travel route to a travel route from a current location of the on-board terminal to the end point in a case that the on-board terminal deviates from the travel route.

In one embodiment, referring to FIG. 27, the travel information includes the travel route and the moving progress. The apparatus further includes a second update module 2605, configured to: determine a location of the on-board terminal on the travel route every second duration based on the current location of the on-board terminal and the travel route; and update the moving progress of the on-board terminal based on the location of the on-board terminal on the travel route.

In one embodiment, referring to FIG. 27, the sharing module 2603 is further configured to implement any one of the following: transmitting, in a case that the on-board terminal ends a current trip, a trip end message to a terminal logged in by the second user, the trip end message being configured for prompting the on-board terminal to end the current trip; or transmitting, in response to a sharing cancel operation, a sharing cancel message to the terminal logged in by the second user, the sharing cancel message being configured for prompting the on-board terminal to cancel sharing of the travel information.

In one embodiment, referring to FIG. 27, the apparatus further includes a voice collection module 2606, configured to: collect first voice information by using the on-board map application, the first voice information carrying an operation keyword, an application keyword, and a user keyword, the operation keyword being configured for indicating performing an operation of sharing the travel information, the application keyword being configured for indicating that sharing is to be performed by using the on-board social application, and the user keyword being configured for indicating that a shared user is the second user. The calling module 2602 is configured to: call, in response to an operation of collecting the first voice information, the on-board social application indicated by the application keyword. The sharing module 2603 is configured to: share, by using the on-board social application, the travel information with the second user indicated by the user keyword.

In one embodiment, referring to FIG. 27, the apparatus further includes a voice collection module 2606, configured to: collect second voice information by using the on-board map application, the second voice information carrying an operation keyword and a user keyword, the operation keyword being configured for indicating performing an operation of sharing the travel information, and the user keyword being configured for indicating that a shared user is the second user. The calling module 2602 is configured to: call a default on-board social application in response to an operation of collecting the second voice information; or query from historical sharing records, in response to an operation of collecting the second voice information, the on-board social application of the second user indicated by the user keyword, and call the on-board social application.

In one embodiment, referring to FIG. 27, the apparatus further includes a voice collection module 2606, configured to: collect third voice information by using the on-board map application, the third voice information carrying an operation keyword and an application keyword, the operation keyword being configured for indicating performing an operation of sharing the travel information, and the application keyword being configured for indicating that sharing is to be performed by using the on-board social application. The calling module 2602 is configured to: call, in response to an operation of collecting the third voice information, the on-board social application indicated by the application keyword. The sharing module 2603 is configured to: select, by using the on-board social application, the second user from users having a social relationship with the first user, and share the travel information with the second user.

In one embodiment, referring to FIG. 27, the sharing module 2603 is configured to: display a user selection interface by using the on-board social application, the user selection interface displaying at least one user having the social relationship with the first user and a first keyword of each user, the first keyword being configured for indicating selecting the user; and share the travel information with the second user in response to an operation of collecting a fourth voice information, the fourth voice information carrying a first keyword of the second user.

In one embodiment, referring to FIG. 27, the travel information includes a first travel route of the on-board terminal. The sharing module 2603 is further configured to: determine a second travel route based on the first travel route and the location of the second user in response to the sharing operation, the second travel route being a route with a highest degree of overlap with the first travel route among candidate travel routes, the candidate travel route being a route of which a start point is at the location of the second user, and an end point is the same as an end point of the first travel route; and share the travel information and the second travel route with the second user by using the on-board social application.

In one embodiment, referring to FIG. 27, the sharing module 2603 includes: a first transmission unit 2613, configured to transmit the travel information to a map server by using the on-board map application; and a second transmission unit 2623, configured to transmit a sharing request to the map server by using the on-board social application, the sharing request being configured for indicating sharing the travel information with the second user.

In one embodiment, referring to FIG. 27, the travel information includes a route identifier of a travel route being navigated to. The first transmission unit 2613 is configured to: transmit the route identifier to the map server by using the on-board map application, the sharing request being configured for indicating sharing the travel route indicated by the route identifier with the second user.

In one embodiment, referring to FIG. 27, the travel information further includes a moving progress. The moving progress is a progress of the on-board terminal moving along the travel route. The first transmission unit 2613 is configured to transmit the route identifier and the moving progress to the map server by using the on-board map application, the sharing request being configured for indicating sharing the travel route indicated by the route identifier and the moving progress with the second user.

In one embodiment, referring to FIG. 27, the display module 2601 is configured to: display a route planning interface by using the on-board map application, the route planning interface displaying a planned travel route; or display a route navigation interface by using the on-board map application, the route navigation interface displaying the travel route being navigated to.

In one embodiment, referring to FIG. 27, the apparatus further includes: a receiving module 2607, configured to receive a location of the second user, the location of the second user being a location of the terminal logged in by the second user. The display module 2601 is further configured to display a location of the on-board terminal and the location of the second user in the travel interface of the on-board terminal.

In the travel information sharing apparatus provided in the foregoing embodiment, the division of the foregoing functional modules is merely described as an example. In actual application, the foregoing functions are assigned to and completed by different functional modules as required. In other words, an internal structure of the on-board terminal is divided into different functional modules to complete all or some of the functions described above. In addition, the travel information sharing apparatus provided in the foregoing embodiment and embodiments of the travel information sharing method are based on the same conception. For a specific implementation process thereof, reference may be made to the method embodiments. Details are not described herein again.

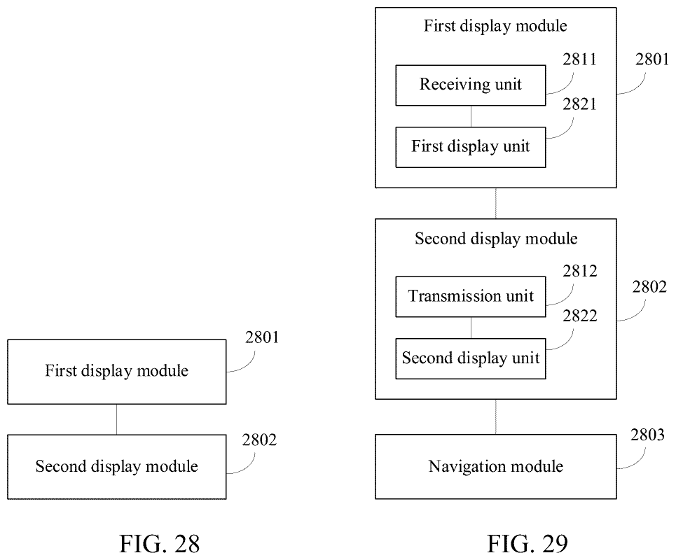

FIG. 28 is a schematic diagram of a structure of another travel information sharing apparatus according to an embodiment of this application. The apparatus is used in an on-board terminal. As shown in FIG. 28, the apparatus includes: a first display module 2801, configured to display a sharing message by using an on-board map application, the sharing message being provided by an on-board social application; and a second display module 2802, configured to display, in response to a trigger operation on the sharing message, travel information associated with the sharing message. The travel information is shared by a third user to a fourth user, the fourth user is a user of an on-board terminal logging into the on-board social application, and the third user has a social relationship with the fourth user.

According to the travel information sharing apparatus provided in this embodiment, the on-board terminal runs the on-board map application and the on-board social application. The on-board map application provides travel information for the on-board terminal. The fourth user logs into the on-board social application. When the sharing message is obtained, the on-board social application provides the sharing message for the on-board map application, so that the on-board terminal displays the sharing message by using the on-board map application. When the sharing message is triggered, the travel information associated with the sharing message is displayed. In this way, the travel information of the third user is shared to the fourth user, and the user can view, on the on-board terminal, the travel information shared by a friend, so that a function of the on-board terminal is expanded, and travel information that can be displayed on the on-board terminal is enriched.

In one embodiment, referring to FIG. 29, the travel information includes travel information of the terminal logged in by the third user and a second travel route. The second travel route is a travel route recommended to the fourth user. The apparatus further includes: a navigation module 2803, configured to perform, in response to a navigation operation, navigation based on the second travel route in a case that the second travel route is displayed.

In one embodiment, referring to FIG. 29, the first display module 2801 includes: a receiving unit 2811, configured to receive, by using the on-board social application, the sharing message transmitted by a map server, and transmit the sharing message to the on-board map application; and a first display unit 2821, configured to receive, by using the on-board map application, the sharing message transmitted by the on-board social application, and display the sharing message.

In one embodiment, referring to FIG. 29, the second display module 2802 includes: a transmission unit 2812, configured to transmit an information obtaining request to the map server in response to the trigger operation on the sharing message, the information obtaining request being configured for requesting to obtain the travel information associated with the sharing message; and a second display unit 2822, configured to receive the travel information transmitted by the map server, and display the travel information.

In one embodiment, referring to FIG. 29, the second display module 2802 is configured to perform any of the following: displaying a planned travel route; or displaying a travel route being navigated to and a moving progress, the moving progress being a progress of the terminal logged in by the third user moving along the travel route.

In one embodiment, referring to FIG. 29, the second display module 2802 is further configured to perform at least one of the following: displaying at least one waypoint on the travel route; displaying at least one road section on the travel route based on a traffic status of the at least one road section on the travel route; displaying a user identifier of the third user at a location of the terminal logged in by the third user; displaying a location of the on-board terminal; or displaying time information when the travel information is last updated.

In one embodiment, referring to FIG. 29, the second display module 2802 is further configured to perform any of the following: displaying, in a case that a trip end message for the travel information is received, the trip end message, the trip end message being configured for prompting the terminal logged in by the third user to end a current trip; displaying, in a case that the sharing cancel message for the travel information is received, a sharing cancel message, the sharing cancel message being configured for prompting the terminal logged in by the third user to cancel sharing of the travel information; or canceling display of the travel information in a case that duration since the travel information is obtained last time reaches second duration, and displaying a sharing interruption message, the sharing interruption message being configured for prompting an interruption in sharing the travel information.

In the travel information sharing apparatus provided in the foregoing embodiment, the division of the foregoing functional modules is merely described as an example. In actual application, the foregoing functions are assigned to and completed by different functional modules as required. In other words, an internal structure of the on-board terminal is divided into different functional modules to complete all or some of the functions described above. In addition, the travel information sharing apparatus provided in the foregoing embodiment and embodiments of the travel information sharing method are based on the same conception. For a specific implementation process thereof, reference may be made to the method embodiments. Details are not described herein again.

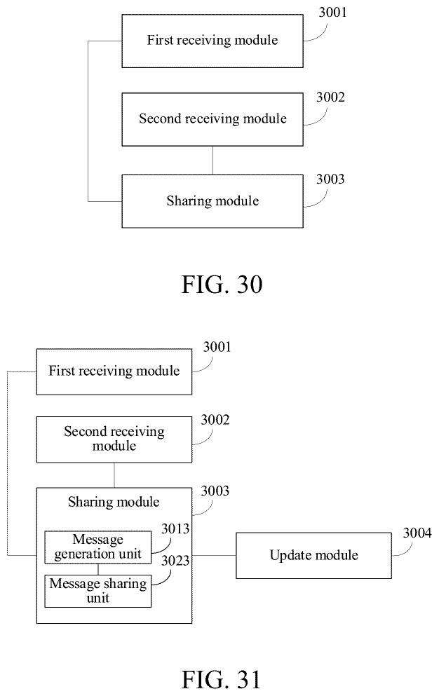

FIG. 30 is a schematic diagram of a structure of another travel information sharing apparatus according to an embodiment of this application. The apparatus is used in a map server. As shown in FIG. 30, the apparatus includes: a first receiving module 3001, configured to receive travel information transmitted by an on-board terminal by using an on-board map application; a second receiving module 3002, configured to receive a sharing request transmitted by the on-board terminal by using an on-board social application, the sharing request being configured for indicating sharing the travel information with a second user; and a sharing module 3003, configured to share the travel information with the second user in response to the sharing request.

According to the travel information sharing apparatus provided in this embodiment, the map server may communicate with the on-board map application and the on-board social application. When the map server receives the travel information transmitted by the on-board terminal by using the on-board map application and receives the sharing request transmitted by the on-board terminal by using the on-board social application, the map server shares the travel information with the second user based on indication of the sharing request. In this way, a function of sharing the travel information is provided for the on-board terminal, and a function of the on-board terminal is expanded.

In one embodiment, referring to FIG. 31, the sharing module 3003 includes: a message generation unit 3013, configured to generate a sharing message, the sharing message being associated with a mini program interface including the travel information, and the sharing message being configured for accessing the mini program interface including the travel information when being triggered; and a message sharing unit 3023, configured to share the sharing message with the second user.

In one embodiment, referring to FIG. 31, the apparatus further includes an update module 3004, configured to perform any of the following: updating the mini program interface based on received updated travel information; updating the mini program interface based on a received trip end message, an updated mini program interface including the trip end message, and the trip end message being configured for prompting the on-board terminal to end a current trip; updating the mini program interface based on a received sharing cancel message, the updated mini program interface including the sharing cancel message, and the sharing cancel message being configured for prompting the on-board terminal to cancel sharing of the travel information; or updating the mini program interface in a case that duration since the travel information is received last time reaches third duration, an updated mini program interface including a sharing interruption message, and the sharing interruption message being configured for prompting an interruption in sharing the travel information.

In the travel information sharing apparatus provided in the foregoing embodiment, the division of the foregoing functional modules is merely described as an example. In actual application, the foregoing functions are assigned to and completed by different functional modules as required. In other words, an internal structure of the map server is divided into different functional modules to complete all or some of the functions described above. In addition, the travel information sharing apparatus provided in the foregoing embodiment and embodiments of the travel information sharing method are based on the same conception. For a specific implementation process thereof, reference may be made to the method embodiments. Details are not described herein again.

An embodiment of this application further provides a computer device. The computer device includes a processor and a memory. The memory has at least one computer program stored therein, and the at least one computer program is loaded and executed by the processor to implement the travel information sharing method in the foregoing embodiments.

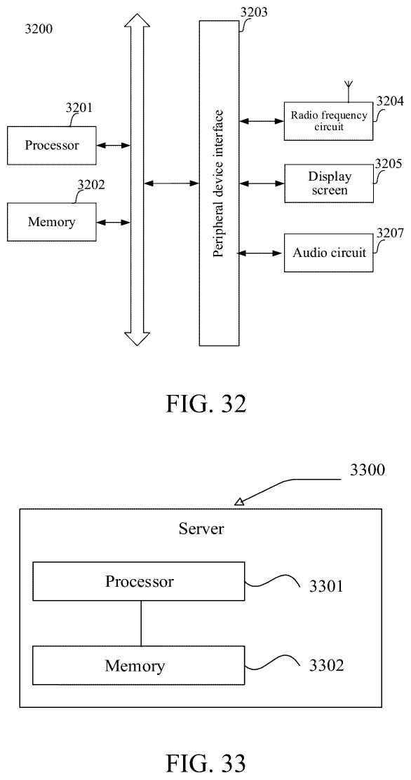

In one embodiment, the computer device is provided as a terminal, for example, an on-board terminal. FIG. 32 is a schematic diagram of a structure of a terminal 3200 according to an exemplary embodiment of this application. The terminal 3200 includes: a processor 3201 and a memory 3202.

The processor 3201 includes one or more processing cores, for example, a 4-core processor or an 8-core processor. The processor 3201 is implemented in at least one hardware form of a digital signal processor (DSP), a field-programmable gate array (FPGA), and a programmable logic array (PLA). The processor 3201 also includes a main processor and a coprocessor. The main processor is a processor configured to process data in an awake state, and is also referred to as a central processing unit (CPU). The coprocessor is a low-power-consumption processor configured to process data in a standby state. In some embodiments, the processor 3201 is integrated with a graphics processing unit (GPU). The GPU is configured to render and draw content to be displayed on a display screen. In some embodiments, the processor 3201 further includes an artificial intelligence (AI) processor. The AI processor is configured to process computing operations related to machine learning.

The memory 3202 includes one or more computer-readable storage media. The computer-readable storage medium is non-transient. The memory 3202 may further include a high-speed random access memory and a nonvolatile memory, for example, one or more disk storage devices or flash storage devices. In some embodiments, the non-transitory computer-readable storage medium in the memory 3202 is configured to store at least one computer program. The at least one computer program is used by the processor 3201 to implement the travel information sharing method provided in the method embodiments of this application.

In some embodiments, the terminal 3200 may alternatively include: a peripheral device interface 3203 and at least one peripheral device. The processor 3201, the memory 3202, and the peripheral device interface 3203 are connected via a bus or a signal cable. Each peripheral device is connected to the peripheral device interface 3203 via a bus, a signal cable, or a circuit board. In one embodiment, the peripheral device includes at least one of a radio frequency circuit 3204, a display screen 3205, or an audio circuit 3207.

The peripheral device interface 3203 may be configured to connect at least one peripheral device related to input/output (I/O) to the processor 3201 and the memory 3202. In some embodiments, the processor 3201, the memory 3202, and the peripheral device interface 3203 are integrated on the same chip or circuit board. In some other embodiments, any one or two of the processor 3201, the memory 3202, and the peripheral device interface 3203 are implemented on a single chip or circuit board. This is not limited in this embodiment.

The radio frequency circuit 3204 is configured to receive and transmit a radio frequency (RF) signal, also referred to as an electromagnetic signal. The radio frequency circuit 3204 communicates with a communication network and another communication device through the electromagnetic signal. The radio frequency circuit 3204 converts an electrical signal into an electromagnetic signal for transmission, or converts a received electromagnetic signal into an electrical signal. In one embodiment, the radio frequency circuit 3204 includes an antenna system, an RF transceiver, one or more amplifiers, a tuner, an oscillator, a digital signal processor, a codec chip set, a subscriber identity module card, and the like. The radio frequency circuit 3204 communicates with another device by using at least one wireless communication protocol. The wireless communication protocol includes, but is not limited to: a metropolitan area network, generations of mobile communication networks (2G, 3G, 4G, and 5G), a wireless local area network and/or a wireless fidelity (Wi-Fi) network. In some embodiments, the radio frequency circuit 3204 further includes a circuit related to near field communication (NFC). This is not limited in this application.

The display screen 3205 is configured to display a user interface (UI). The UI includes a graph, text, an icon, a video, and any combination thereof. When the display screen 3205 is a touch display screen, the display screen 3205 also has a capability to collect a touch signal on or above the surface of the display screen 3205. The touch signal is inputted to the processor 3201 as a control signal for processing. In this case, the display screen 3205 is further configured to provide a virtual button and/or a virtual keyboard, which is also referred to as a soft button and/or a soft keyboard. In some embodiments, there is one display screen 3205 disposed on a front panel of the terminal 3200. In some other embodiments, there are at least two display screens 3205 disposed on different surfaces of the terminal 3200 respectively or in a folded design. In some other embodiments, the display screen 3205 is a flexible display screen disposed on a curved surface or a folded surface of the terminal 3200. Even, the display screen 3205 is further configured in a non-rectangular irregular pattern, namely, a special-shaped screen. The display screen 3205 is prepared by using materials such as a liquid crystal display (LCD) or an organic light-emitting diode (OLED).

The audio circuit 3207 includes a microphone and a speaker. The microphone is configured to collect sound waves of a user and an environment, and convert the sound waves into an electrical signal to input to the processor 3201 for processing, or input to the radio frequency circuit 3204 for implementing voice communication. For a purpose of stereo collection or noise reduction, there are a plurality of microphones disposed at different portions of the terminal 3200 respectively. In one embodiment, the microphone is an array microphone or an omni-directional collection type microphone. The speaker is configured to convert an electrical signal from the processor 3201 or the radio frequency circuit 3204 into sound waves. The speaker is a conventional film speaker, or a piezoelectric ceramic speaker. When the speaker is the piezoelectric ceramic speaker, the speaker not only converts an electric signal into sound waves audible to a human being, but also converts an electric signal into sound waves inaudible to a human being, for ranging and other purposes. In some embodiments, the audio circuit 3207 further includes an earphone jack.

A person skilled in the art understands that the structure shown in FIG. 32 does not constitute a limitation to the terminal 3200, and the terminal 3200 includes more or fewer components than those shown in the figure, or some components may be combined, or a different component deployment may be used.

In one embodiment, the computer device is provided as a server. FIG. 33 is a schematic diagram of a structure of a server according to an embodiment of this application. The server 3300 may vary a lot due to different configurations or performance, and includes one or more processors (central processing units, CPUs) 3301 and one or more memories 3302. The memory 3302 has at least one computer program stored therein, and the at least one computer program is loaded and executed by the processor 3301 to implement the method provided in the foregoing method embodiments. Certainly, the server further includes components such as a wired or wireless network interface, a keyboard, and an input/output interface, to facilitate input and output. The server further includes another component configured to implement a function of a device. Details are not described herein again.

An embodiment of this application further provides a computer-readable storage medium, having at least one computer program stored thereon. The at least one computer program is loaded and executed by a processor to implement the travel information sharing method according to the foregoing embodiments.

An embodiment of this application further provides a computer program product, including a computer program. The computer program is loaded and executed by a processor to implement the travel information sharing method according to the foregoing embodiments.

A person of ordinary skill in the art understands that all or some of the operations of the foregoing embodiments are implemented by hardware, or implemented by a program instructing relevant hardware. The program is stored on a computer-readable storage medium. The storage medium is a read-only memory, a magnetic disk, an optical disc, or the like.

The foregoing descriptions are merely exemplary embodiments of embodiments of this application, and are not intended to limit embodiments of this application. Any modification, equivalent replacement, or improvement made within the spirit and principle of embodiments of this application fall within the protection scope of this application.

What is claimed is:

1. A travel information sharing method, performed by an on-board terminal, the method comprising:
displaying a travel interface of the on-board terminal by using an on-board map application, the travel interface displaying current travel information of the on-board terminal;
calling an on-board social application in response to a sharing operation in the travel interface, the sharing operation being configured for indicating sharing the travel information; and
sharing, by using the on-board social application, the travel information with a second user associated with a first user, the first user being a user of the on-board terminal logging into the on-board social application.

2. The method according to claim 1, further comprising:
sharing updated travel information with the second user in a case that the travel information is updated.

3. The method according to claim 2, wherein the sharing updated travel information with the second user in a case that the travel information is updated comprises at least one of the following:
the travel information comprising a travel route, sharing an updated travel route with the second user in a case that the travel route is updated; or
the travel information comprising a moving progress, and the moving progress being a progress of the on-board terminal moving along the travel route, obtaining an updated moving progress every first duration, and sharing the updated moving progress with the second user.

4. The method according to claim 2, wherein the travel information comprises the travel route, and the method further comprises one of the following:
updating, in response to a switch operation on a route requirement, the travel route to a travel route that satisfies a switched route requirement;
updating, in response to a modification operation on a waypoint, the travel route to a travel route passing by a modified waypoint;
updating, in response to a route switch operation, the travel route to a travel route indicated by the route switch operation; or
the travel route comprising an end point, updating the travel route to a travel route from a current location of the on-board terminal to the end point in a case that the on-board terminal deviates from the travel route.

5. The method according to claim 2, wherein the travel information comprises the travel route and the moving progress, the moving progress is the progress of the on-board terminal moving along the travel route, and the method further comprises:
determining a location of the on-board terminal on the travel route every second duration based on the current location of the on-board terminal and the travel route; and
updating the moving progress of the on-board terminal based on the location of the on-board terminal on the travel route.

6. The method according to claim 1, further comprising one of the following:
transmitting, in a case that the on-board terminal ends a current trip, a trip end message to a terminal logged in by the second user, the trip end message being configured for prompting the on-board terminal to end the current trip; or
transmitting, in response to a sharing cancel operation, a sharing cancel message to the terminal logged in by the second user, the sharing cancel message being configured for prompting the on-board terminal to cancel sharing of the travel information.

7. The method according to claim 1, further comprising:
collecting first voice information by using the on-board map application, the first voice information carrying an operation keyword, an application keyword, and a user keyword, the operation keyword being configured for indicating performing an operation of sharing the travel information, the application keyword being configured for indicating that sharing is to be performed by using the on-board social application, and the user keyword being configured for indicating that a shared user is the second user;
the calling an on-board social application in response to a sharing operation in the travel interface comprises:
calling, in response to an operation of collecting the first voice information, the on-board social application indicated by the application keyword; and
the sharing, by using the on-board social application, the travel information with a second user associated with a first user comprises:
sharing, by using the on-board social application, the travel information with the second user indicated by the user keyword.

8. The method according to claim 1, further comprising:
collecting second voice information by using the on-board map application, the second voice information carrying an operation keyword and a user keyword, the operation keyword being configured for indicating performing an operation of sharing the travel information, and the user keyword being configured for indicating that a shared user is the second user; and
the calling an on-board social application in response to a sharing operation in the travel interface comprises:
calling a default on-board social application in response to an operation of collecting the second voice information; or
querying from historical sharing records, in response to an operation of collecting the second voice information, the on-board social application of the second user indicated by the user keyword, and calling the on-board social application.

9. The method according to claim 1, further comprising:
collecting third voice information by using the on-board map application, the third voice information carrying an operation keyword and an application keyword, the operation keyword being configured for indicating performing an operation of sharing the travel information, and the application keyword being configured for indicating that sharing is to be performed by using the on-board social application;
the calling an on-board social application in response to a sharing operation in the travel interface comprises:
calling, in response to an operation of collecting the third voice information, the on-board social application indicated by the application keyword; and
the sharing, by using the on-board social application, the travel information with a second user associated with a first user comprises:
selecting, by using the on-board social application, the second user from users having a social relationship with the first user, and sharing the travel information with the second user.

10. The method according to claim 9, wherein the selecting, by using the on-board social application, the second user from users having a social relationship with the first user, and sharing the travel information with the second user comprises:
displaying a user selection interface by using the on-board social application, the user selection interface displaying at least one user having the social relationship with the first user and a first keyword of each user, the first keyword being configured for indicating selecting the user; and
sharing the travel information with the second user in response to an operation of collecting a fourth voice information, the fourth voice information carrying a first keyword of the second user.

11. The method according to claim 1, further comprising:
receiving a location of the second user, the location of the second user being a location of the terminal logged in by the second user; and
displaying a location of the on-board terminal and the location of the second user in the travel interface of the on-board terminal.

12. The method according to claim 1, wherein the travel information comprises a first travel route of the on-board terminal, and the method further comprises:
determining a second travel route based on the first travel route and the location of the second user in response to the sharing operation, the second travel route being a route with a highest degree of overlap with the first travel route among candidate travel routes, the candidate travel route being a route of which a start point is at the location of the second user, and an end point is the same as an end point of the first travel route, and the location of the second user being the location of the terminal logged in by the second user; and
the sharing, by using the on-board social application, the travel information with a second user associated with a first user comprises:
sharing the travel information and the second travel route with the second user by using the on-board social application.

13. The method according to claim 1, wherein the sharing, by using the on-board social application, the travel information with a second user associated with a first user comprises:
transmitting the travel information to a map server by using the on-board map application; and
transmitting a sharing request to the map server by using the on-board social application, the sharing request being configured for indicating sharing the travel information with the second user.

14. The method according to claim 13, wherein the travel information comprises a route identifier of a travel route being navigated to, and the transmitting the travel information to a map server by using the on-board map application comprises:
transmitting the route identifier to the map server by using the on-board map application, the sharing request being configured for indicating sharing the travel route indicated by the route identifier with the second user.

15. The method according to claim 14, wherein the travel information further comprises the moving progress, the moving progress being configured for indicating the progress of the on-board terminal moving along the travel route; and
the transmitting the route identifier to the map server by using the on-board map application comprises:
transmitting the route identifier and the moving progress to the map server by using the on-board map application, the sharing request being configured for indicating sharing the travel route indicated by the route identifier and the moving progress with the second user.

16. The method according to claim 1, wherein the displaying a travel interface of the on-board terminal by using an on-board map application comprises:
displaying a route planning interface by using the on-board map application, the route planning interface displaying a planned travel route; or
displaying a route navigation interface by using the on-board map application, the route navigation interface displaying the travel route being navigated to.

17. A travel information sharing method, performed by an on-board terminal, the method comprising:
displaying a sharing message by using an on-board map application, the sharing message being provided by an on-board social application; and
displaying, in response to a trigger operation on the sharing message, travel information associated with the sharing message,
the travel information being shared by a third user to a fourth user, the fourth user being a user of the on-board terminal logging into the on-board social application, and the third user having a social relationship with the fourth user.

18. The method according to claim 17, wherein the displaying a sharing message by using an on-board map application comprises:
receiving, by using the on-board social application, the sharing message transmitted by a map server, and transmitting the sharing message to the on-board map application; and
receiving, by using the on-board map application, the sharing message transmitted by the on-board social application, and displaying the sharing message.

19. The method according to claim 17, wherein the displaying, in response to a trigger operation on the sharing message, travel information associated with the sharing message comprises:
transmitting an information obtaining request to the map server in response to the trigger operation on the sharing message, the information obtaining request being configured for requesting to obtain the travel information associated with the sharing message; and
receiving the travel information transmitted by the map server, and displaying the travel information.

20. A computer device, comprising a processor and a memory, the memory having at least one computer program stored therein, and the at least one computer program being loaded and executed by the processor to implement a travel information sharing method, performed by an on-board terminal, the method comprising:
displaying a travel interface of the on-board terminal by using an on-board map application, the travel interface displaying current travel information of the on-board terminal;
calling an on-board social application in response to a sharing operation in the travel interface, the sharing operation being configured for indicating sharing the travel information; and
sharing, by using the on-board social application, the travel information with a second user associated with a first user, the first user being a user of the on-board terminal logging into the on-board social application, and the second user being a user having a social relationship with the first user.
